(19) United States
(12) Patent Application Publication
(10) Pub. No.: US 2010/0020160 A1
(43) Pub. Date: Jan. 28, 2010

(54) Stereoscopic Motion Picture

(76) Inventor: James Amachi Ashbey, London (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 12/309,052

(22) PCT Filed: Jul. 5, 2007
(86) PCT No.: PCT/GB07/50383

§ 371 Date: Sep. 10, 2009

(30) Foreign Application Priority Data
Jul. 5, 2006 (GB) 0613352.4

(51) Int. Cl. H04N 13/00

(52) U.S. Cl. 348/43; 348/E13.001

(57) ABSTRACT

A stereoscopic motion picture sequence comprises a first channel of sequential images intended for viewing by one of a viewer's left and right eyes and a second channel of sequential images intended for viewing by the other one of the viewer's left and right eyes. Each image in each channel comprises primary image content representing a scene consisting of a plurality of elements and ‘temporal shadow’ image content. The temporal shadow image content in a first image comprises a degraded and/or partially transparent image of at least one element of the primary image content corresponding to a view of said at least one element as seen in the primary image content of a second image from the first or second channel. The temporal shadow images provide additional cognitive cues assisting the viewer's perception of the stereoscopic image sequence as having 3D depth. The temporal shadows may be used to augment conventional stereoscopic motion pictures and are particularly useful in relation to pseudo-stereoscopic ‘time parallax’ motion pictures derived from a 2D motion picture sequence by duplicating the original motion picture sequence in two (left and right) channels and applying a relative lateral displacement and relative time delay to the duplicated channels. Methods and systems for producing such motion picture sequences are also described, together with a modified display screen (or motion picture sequence) having a border pattern incorporating irregular protruding edge details:

The present invention relates to stereoscopic motion picture sequences and to methods and apparatus for generating stereoscopic motion picture sequences.

As used herein, the term “stereoscopic motion picture sequence” encompasses any kind of motion picture sequence comprising a first channel of sequential images intended for viewing by one of a viewer's left and right eyes and a second channel of sequential images intended for viewing by the other one of the viewer's left and right eyes, so as to create the illusion of depth (“3D”) in the perceived image, the sequence being recorded and/or encoded in any medium and any format, including optical and electronic and analogue and digital media and formats. The two channels referred to may be discrete, separate channels, or overlaid (multiplexed), as is well known in the art.

Stereoscopic imaging is well known and will not be discussed in detail. As used herein, the term “stereoscopic” includes “genuine” (conventional) stereoscopy, in which stereoscopic image pairs are obtained, for example, by simultaneously capturing two images of a subject from slightly differing viewpoints, and “pseudo” stereoscopy, in which “pseudo” stereoscopic image pairs are synthesized from conventional 2D motion picture sequences. The term “pseudo-stereoscopic” as used herein has this meaning.

The invention does not depend on any particular 3D display or viewing technology. Stereoscopic motion picture sequences in accordance with the invention may be adapted for display/viewing using shutter glasses (such as LCD shutter glasses), circularly or linearly polarized glasses, anaglyph glasses etc., and “glasses-free” 3D display technologies, as are well known in the art.

The invention is particularly concerned with pseudo-stereoscopic motion picture sequences but is also applicable to stereoscopic motion picture sequences produced by other means.

### BACKGROUND TO THE INVENTION

It is known that a pseudo-stereoscopic effect can be obtained from conventional 2D motion picture footage if the original footage is duplicated to provide two separate left and right channels and: (a) one of the channels is delayed in time slightly relative to the other and (b) the images of the respective channels are laterally displaced slightly relative to one another. For moving subjects within the image sequence, the slight differences in perspective between successive 2D frames provide the basis for approximate stereoscopic pairs when presented in this manner. This effect is enhanced by the lateral displacement of the right- and left-hand images. In this basic form, this known pseudo-stereoscopic effect (also sometimes known as “time parallax”) is of limited practical value and does not in itself enable a sustained and convincing 3D effect except in limited circumstances.

The present invention, in one aspect, seeks to improve the quality of stereoscopic motion picture sequences synthesized from 2D motion picture in this way. In another aspect, the invention further seeks to improve the quality of stereoscopic motion picture sequences, however the sequences are generated (e.g. by stereo cinematography, by CGI techniques—i.e. 3D computer modelling and rendering whereby stereoscopic image pairs are generated, digital image capturing and processing etc.).

Conventional stereoscopic imaging simply seeks to present each eye with a separate view of a scene that simulates the monocular view that would be received by each eye if viewing the scene directly. That is, it is a purely geometrical/optical approach concerned only with the optical input received by each retina. This approach can produce striking and convincing 3D images, but in reality it can provide only a very crude approximation of the way in which the 3D world is actually perceived by human beings. A real person does not stare fixedly at a scene in the way that a stereoscopic camera pair does, and does not stare fixedly at a cinema screen in a way that matches the projected stereoscopic images. Accordingly, extended viewing of conventional stereoscopic motion picture sequences can be disorienting, strain-inducing and ultimately unconvincing.

### SUMMARY OF THE INVENTION

The present invention arises from a recognition that human perception of the 3D world is a much more subtle and complex process than the simple combination of monocular images from each eye. In particular, the invention is based on the recognition that human binocular vision/perception involves the continual processing of overlapping “double images”, that from moment to moment are consciously perceived as double images to a greater or lesser extent as the focus of attention shifts around a scene.

In broad terms, the invention enhances conventional stereoscopic motion picture sequences (including pseudo-stereoscopic sequences) by incorporating additional 3D cues into each frame (or each video field, in the case of interlaced video formats) of each channel in the form of additional images elements, referred to herein as “temporal shadows”. The temporal shadows in each frame of one channel are degraded and/or partially transparent representations of some or all of the image elements of the current frame, derived from corresponding or closely adjacent image frames from the one or other of the channels. That is, the temporal shadows included in the right eye version of one frame are typically derived from the left eye version of the same frame, or a closely adjacent frame from either channel, and vice versa. In the case of preferred pseudo-stereoscopic conversion processes described herein, the temporal shadows are derived from frames that precede or succeed the current frame in time. The expression “temporal shadow” derives from this time-shifted origin of the temporal shadow images in the case of pseudo-stereoscopic conversion processes, but is used herein, for convenience, to refer to such images serving the same purpose of providing enhanced 3D visual cues, however they are derived.

Clearly, this approach necessarily reduces the objective accuracy of the image presented in each frame in terms of what would be perceived instantaneously at the retina of each eye. Counter-intuitively, however, it is found that this basic idea provides the basis for a more satisfactory subjective 3D visual experience.

It is noted here that conventional scene transition effects employed in film or video editing, particularly dissolves, may be said to involve images from frames at the end of a first scene being included in images in the frames at the beginning of a succeeding scene. Such conventional editing/transistion techniques/effects are excluded from the scope of the present claims. Similarly, other instances in which images are overlaid in frames of motion picture sequences for creative purposes, rather than for the technical purpose of creating or enhancing stereoscopic effects, are likewise excluded from the scope of the claims.

The parameters according to which the temporal shadows are derived from certain frames and incorporated into other frames can be varied depending on, for example, the nature of the content of a particular sequence (particularly, but not exclusively, the speed of motion of objects within a scene) and the particular subjective effect that is desired to be created by the author of the sequence, as shall be described below by reference to exemplary embodiments of the invention.

In accordance with one aspect, the present invention provides stereoscopic motion picture sequences incorporating additional 3D cues in the form of temporal shadows as described herein.

In accordance with other aspects of the invention, there are provided methods of producing stereoscopic motion picture sequences incorporating additional 3D cues in the form of temporal shadows as described herein.

In accordance with still further aspects of the invention, there are provided data processing systems/apparatus for implementing methods of producing stereoscopic motion picture sequences incorporating additional 3D cues in the form of temporal shadows as described herein.

In accordance with yet a further aspect of the invention, there is provided a display screen for the display of stereoscopic motion picture sequences.

The various aspects of the invention, and further preferred, optional or alternative features thereof, are defined in the claims appended hereto.

Embodiments of the invention will now be described, by way of example only, with reference to the accompanying drawings.

### BRIEF DESCRIPTION OF THE DRAWINGS

FIG. 1 is a schematic block diagram illustrating an example of a data processing system architecture for use in accordance with the present invention.

FIG. 2 is a diagram illustrating an example of a process of comparing two video fields for the purposes of the present invention.

FIG. 3 is a diagram illustrating an example of a process of generating a modified video filed incorporating a temporal shadow image in accordance with the present invention.

FIGS. 4 to 7 are diagrams illustrating the relationships between original images and temporal shadow images;

FIGS. 8 to 12 are diagrams illustrating a number of options for the first stage of a two stage processing scheme in accordance with embodiments of one aspect of the present invention.

FIG. 13 is a diagram illustrating a further example of a process of generating a modified video filed incorporating a temporal shadow image in accordance with the present invention.

FIG. 14 is a diagram illustrating a comparison between an original image and the same image incorporating a temporal shadow.

FIG. 15 is a diagram illustrating an example of original image combined with a temporal shadow in accordance with one optional stage one process.

FIGS. 16 to 20 are diagrams illustrating options for the second stage of a two stage processing scheme in accordance with embodiments of one aspect of the present invention.

FIG. 21 is a diagram illustrating lateral shifts applied to stereoscopic image pairs.

FIGS. 22 and 23 are diagrams illustrating aspects of human 3D vision.

FIGS. 24 to 27 are diagrams illustrating the application of temporal shadows to sequences of video fields.

FIGS. 28 and 29 are diagrams illustrating further aspects of visual effects produced by means of the present invention.

FIG. 30 is a perspective view of a conventional projection/display screen.

FIGS. 31-34 are illustrations of examples of features of an enhanced projection/display screen in accordance with a further aspect of the present invention.

### DETAILED DESCRIPTION OF THE PREFERRED EMBODIMENTS

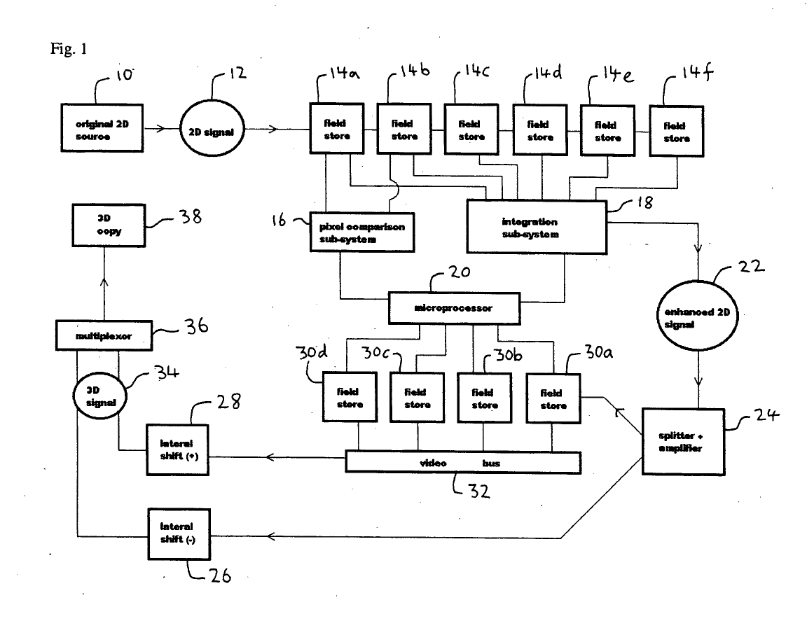

Firstly, examples of systems and methods will be described for the conversion of original 2D motion picture sequences into pseudo-stereoscopic 3D motion picture sequences in accordance with the invention, with reference to an exemplary digital video processing system architecture as illustrated in FIG. 1 of the drawings.

This example presupposes the use of 2D source material in a video format comprising a sequence of image frames, each of which frames comprises an array of pixels divided into first and second fields of interlaced scan lines, as is well known in the art. The original source material may be in an analog format, in which case there would be an analog-digital conversion step (not illustrated). It will be understood that the illustrated system architecture is only one example, and that functionality of the illustrated system could be achieved by a variety of other means, implemented in hardware, firmware, software or combinations thereof. For example, the digital image processing required for the purposes of the present invention could be performed by means of a suitable programmed general purpose computer (this applies to all embodiments of the invention in which the motion picture sequences are represented digitally or are converted to a digital representation). Equally, it will be apparent that motion picture sequences having similar characteristics, in accordance with the present invention, may be generated in other formats, including electronic video formats having more than two fields per frame, progressive scan formats that do not employ interlaced fields, and film. While it is clearly desirable to automate the processing of source material (whether 2D or conventional stereoscopic material) to the greatest extent possible, typically using digital data processing, it can be seen that equivalent results could be obtained by digital or analog signal processing or by optical/photochemical means (in the case of film), with greater or lesser degrees of manual intervention (e.g. in an extreme example, digital image sequences could be processed manually on a frame-by-frame basis).

It is the purpose of the system architecture of FIG. 1 and the sequences of digital processing that it implements—to take a standard 2D video signal and convert it into a 3D (pseudo-stereoscopic) video signal, creating in the process a left eye view and a right eye view, that is in both cases altered from the original image.

As shown in FIG. 1, the exemplary system architecture comprises a source (e.g. media playback device) 10 of an original 2D video signal 12. In this example, the signal 12 represents a sequence of 2D image frames, each frame consisting of two fields. The 2D signal 12 is input to a first set of serially connected field stores (memory modules, six in this example) 14a-14f. The first two field stores 14a, 14b are each connected to a pixel comparison sub-system 16. All of the first series of field stores 14a-14f are connected to an integration sub-system 18. The pixel comparison sub-system 16 and the integration sub-system 18 are in turn connected to a microprocessor 20. The integration sub-system 18 generates as output an enhanced 2D signal 22. The enhanced signal 22 corresponds to the original 2D signal 12, in which each field of each frame has been processed and modified by the integration sub-system 18 as shall be described further below.

The components of the system described thus far serve to implement a first stage (stage one) of a two stage processing scheme.

The microprocessor 20 together with the remaining components implement stage two of the scheme. Stage two takes the enhanced signal 22 as input to a splitter and amplifier module 24, which outputs two identical copies of the enhanced signal 22. One of these copies provides the basis for a left eye channel of the eventual pseudo-stereoscopic (3D) output signal from the system and the other provides the basis for the right eye channel of the 3D output. One copy is input directly to a first lateral shift module 26 of a pair of complementary lateral shift modules 26 and 28. The other copy is input to a first one 30a of a second set of field stores 30a-30d, connected in parallel with one another between the microprocessor 20 and a video bus module 32. The output from the video bus 32 is connected to the second lateral shift module 28. The output from one of the lateral shift modules 26 and 28 provides the right eye channel of a 3D video signal 34 and the output from the other one of the lateral shift modules 26 and 28 provides the left eye channel of the 3D video signal 34. In this preferred embodiment, the two channels of the 3D signal 34 are multiplexed by a multiplexor 36, which outputs a final 3D version 38 of the original 2D source material, which may be encoded in any desired format and recorded in any desired medium.

Stage One Processing

Referring in more detail to stage one of the processing scheme, the purpose of the field stores 14, pixel comparison sub-system 16 and integration sub-system 18, in combination with the microprocessor 20, is to enable the content of individual video frames to be sampled, for the video field samples to be processed, and for the processed samples to be blended with original video fields, such that each original video field is modified to include one or more temporal shadows derived from preceding and/or succeeding video fields.

It will be understood here that for the purposes of the present embodiment, the term “temporal shadow” means at least one sample from at least one video field that has been processed for blending with a preceding or succeeding video field.

As shall be discussed and explained further below, there are several parameters associated with the sampling, processing and blending of the temporal shadows. Generally speaking, the values of these parameters may be varied by a user of the system within and/or between individual motion picture sequences to control the visual 3D effects obtained in a final 3D motion picture presentation.

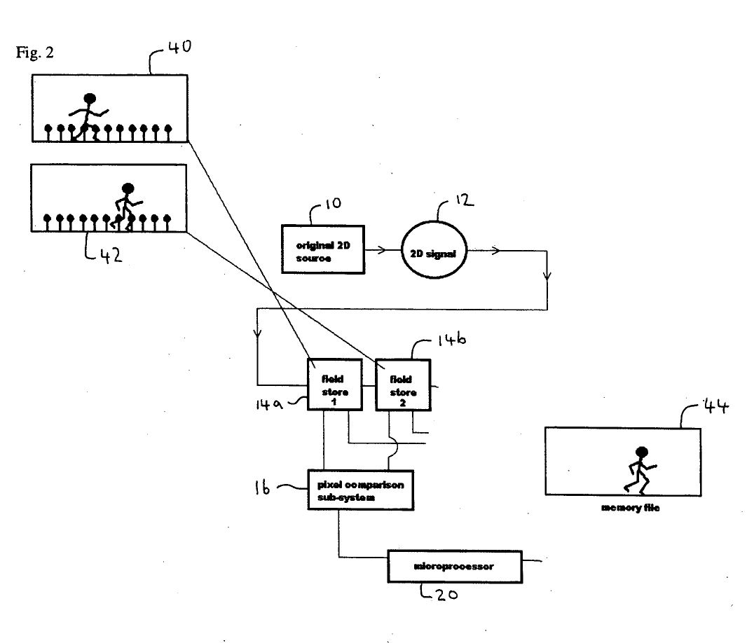

In the example of FIG. 1, and with further reference to FIG. 2, field stores 14a and 14b capture two successive video fields 40 and 42. The pixel comparison sub-system 16 and microprocessor 20 process the contents of the field stores 14a and 14b to determine which pixels have changed between the successive fields; i.e. to detect moving objects within the scene represented by the video fields. Algorithms for the detection of motion in video streams are well known in the art and will not be described in detail herein. The difference between the two fields is stored as a memory file 44 in one of the other field stores 14c-f. In this example, the first field 40 is the reference field and the differences in the succeeding field 42 are stored in the memory file. In this case the image is of a figure running against a static background, and the memory file represents the figure in the second field 42 as it has moved since the first field.

The number of field stores 14 in the first set of field stores may be varied to accommodate the required processing. In particular, more than two field stores 14 may be connected to the pixel comparison sub-system 16 to enable comparisons between multiple fields and/or fields that are not immediately adjacent in the video stream.

A first parameter, then, to be considered in generating a temporal shadow from a particular frame is the extent to which a pixel must move between fields before it is included in the memory file, referred to herein as the pixel displacement. For the purposes of the present invention, one or more threshold values or ranges may be set for the pixel displacement, and the values of other parameters associated with the temporal shadow may be related to the pixel displacement threshold(s)/range(s). As shall be further explained below, more than one memory file may be created from the comparison of the same pair of fields, each corresponding to a different displacement threshold/range and stored in one of the field stores 14c-14f. In this way, each memory file will represent objects or parts of objects in one field that have moved by different amounts relative to the other field. These memory files may then be processed to create either separate temporal shadows or a single composite temporal shadow derived from one of the pair of fields for inclusion in the other one of the fields.

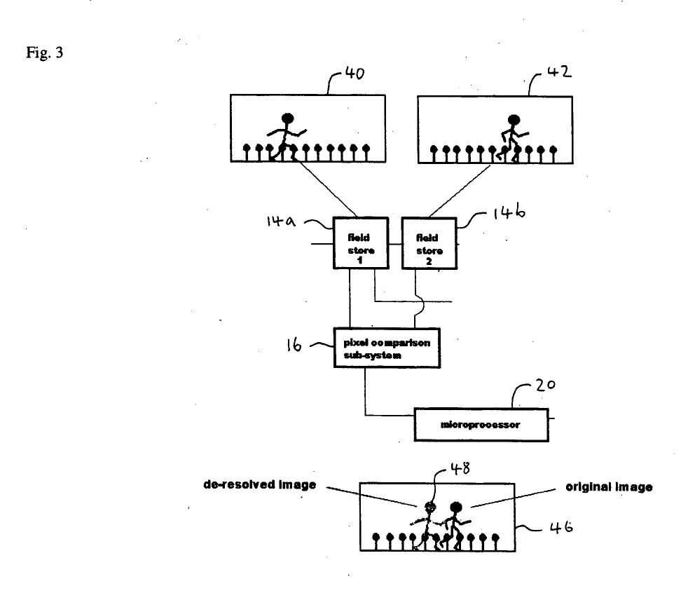

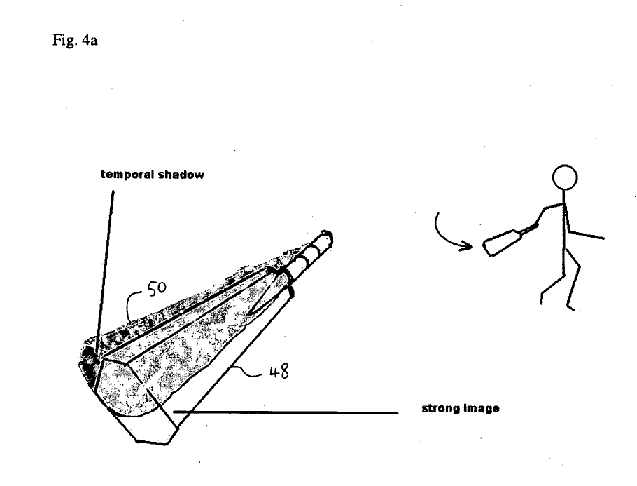

In a simple example, where a single memory file is created on the basis of a single displacement value or range, the content of the memory file is further processed to create the temporal shadow image prior to this being blended with the “current” field (i.e. the reference field against which the other field was compared to create the memory file from which the temporal shadow was derived). This is illustrated in FIG. 3, which shows a processed video field 46 incorporating a temporal shadow 48. In this example, the processed field 46 is based on original field 42 and the temporal shadow is derived from preceding field 40. That is, a memory file is created from the difference between fields 40 and 42, using field 42 as the reference field, and the memory file is processed to create the temporal shadow image which is then blended with the content of the reference field (the “current” field) 42 to create the processed field 46.

In the preferred embodiments of the invention, the processing of the memory file comprises a degradation or de-resolution process, whereby the clarity and/or sharpness of the image represented by the memory file is reduced. A suitable degradation or de-resolution effect can be achieved by means of any of a variety of well known digital graphics filter algorithms, suitably including blurring techniques such as Gaussian blur or noise-addition techniques such as effects that increase the apparent granularity of an image. Such processes will be referred to hereafter simply as “degradation”.

The degree of degradation is a second parameter associated with the temporal shadow. As previously indicated, the value of this parameter may depend on the pixel displacement threshold/range applied in deriving the memory file. Typically, the degree of degradation will increase with increased displacement, so that the temporal shadows for fast moving objects with greater displacements will be degraded to a greater extent than the temporal shadows for slow moving objects with lesser displacements.

The temporal shadow, being a degraded version of the image represented in the memory file, is blended with the reference field to create the final processed field 46. In preferred embodiments, the blending involves applying a degree of transparency to the temporal shadow. In computer graphics, such blending is often referred to as “alpha compositing”. Such techniques are well known in the art and will not be described in detail. The degree of transparency is referred to as the alpha value, i.e. a value between 0 and 1, where 0 represents full transparency and 1 represents full opacity.

The alpha value is a third parameter associated with the temporal shadow and again may vary depending on the pixel displacement threshold/range applied in deriving the memory file. Typically, the degree of transparency will increase (the alpha value will be reduced) with increased displacement, so that the temporal shadows for fast moving objects with greater displacements will be more transparent than the temporal shadows for slow moving objects with lesser displacements.

The degree of degradation and the degree of transparency may be interdependent; i.e. for a given pixel displacement the degree of degradation may be reduced if the transparency is increased. It will be understood that the optimal values of the pixel displacement, degradation and transparency parameters will depend on the content of the motion picture sequence and the desired visual effect. Accordingly, particular values for these parameters are not given here and suitable values for particular applications of the present invention can readily be determined empirically on the basis of the teaching provided herein.

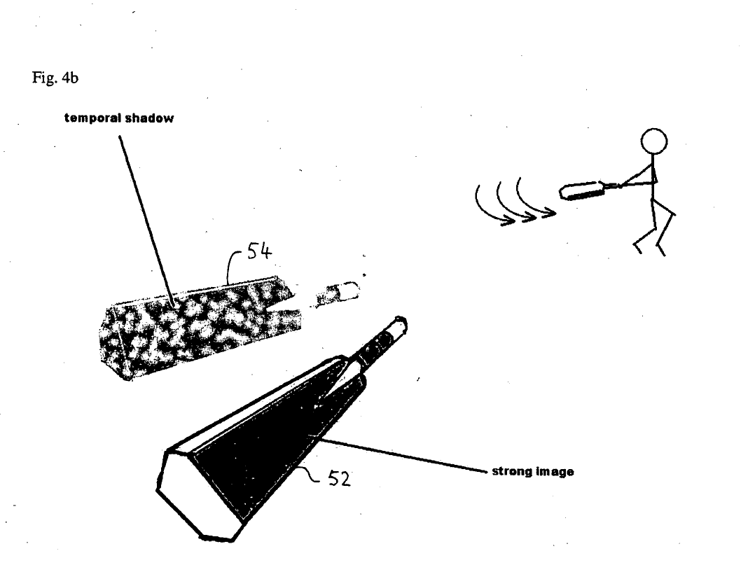

The result of the processing described thus far is that each processed field now comprises a combination of at least two images: a strong, original image (primary image content) and one or more weak de-resolved (degraded) images—the temporal shadow(s). The strong image is an original stream image, and the weak image is a degraded image of those pixels from the immediately preceding (or succeeding) image that moved more than a specified amount or by an amount in a specified range. As a result objects within the final composed image that are slow moving will be represented as a clear object or slightly elongated (by the addition of a relatively strong/clear temporal shadow—see FIG. 4a, showing the outline 48 of the original image of an object and the temporal shadow 50 derived from the preceding video field), but all those that are fast moving will appear either greatly elongated or in two positions: one position clearly defined, and the other degraded (e.g. slightly granular) and/or partially transparent (see FIG. 4b: original object image 52, temporal shadow 54).

Each processed (composed) field, when now looked at on a field-by-field basis, seems slightly less clear and in focus, as some parts of the image now have a slightly less distinct outline, and in the case of objects in rapid motion, they will clearly appear in two positions, albeit one slightly less distinct than the other. (If will of course be virtually impossible to detect this when the sequence of fields is played back, typically at between 50 to 60 fields each second.)

This has the effect of giving moving objects a different profile; e.g. a longer (elongated) profile. This profile is still ‘true’, in that it is transformationally correct, when considered three-dimensionally, as shall now be discussed.

Although these slightly granular, superimposed, de-resolved images (the temporal shadows), have the effect of lowering the clarity and resolution of each video field, when considered two-dimensionally, they also do something much more important and very useful to the overall intention of the processing: they introduce three dimensional information into the two dimensional image of each video field, as follows.

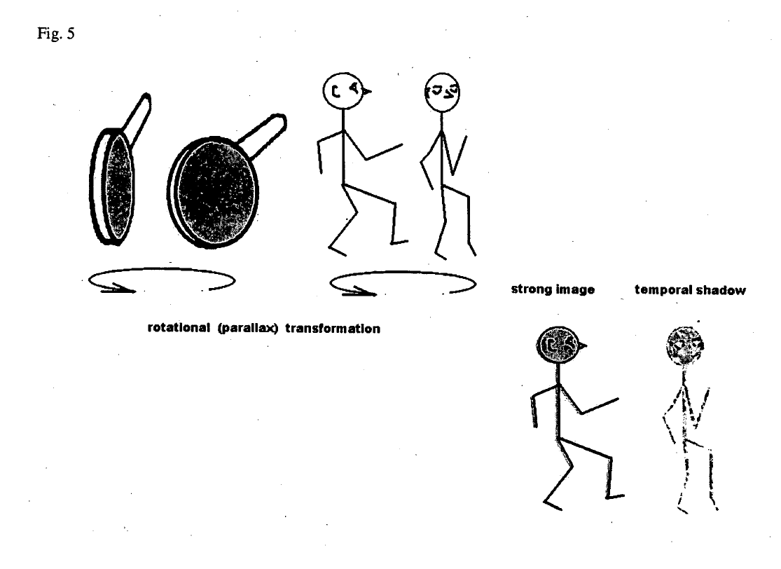

The ‘temporal shadows’ are images of their counterpart objects in the ‘strong’ image, but nearly always have a degree of rotation about them. So they represent a slight rotational transformation upon the original (see FIG. 5, showing examples of rotational transformation in successive images of moving objects). However, unlike a true stereoscopic representation, the planes of the various rotations of the objects in each field are not uniform.

So the processed field now contains additional information, at the expense of a slight drop in clear resolution, but now includes rotational information that gives a slightly different additional (second) perspective of the object. So between each object and its temporal shadow, there are now two perspectives of the same object, and through these two perspectives, we have very important rotational 2D-parallax.

All 3D, stereoscopic imaging involves a rotational parallax between two pictures taken from two similar, but slightly displaced reference points, with one of these two images going to each eye; in the case of pseudo-stereoscopic 3D (that is 3D image pairs created from sequences of single 2D images; i.e. from a single reference point) the strong image could go to one eye and the temporal shadow to the other eye, and when this is the case a slightly stereoscopic effect can be achieved. Indeed the present system is designed to also achieve that basic 3D conversion.

So rotational parallax has always been found in both stereoscopic and pseudo-stereoscopic images, where one of the two images goes to one eye and the other goes to the other eye. The present invention provides a new class of pseudo-stereoscopic processing, in which a new category of rotational parallax is created between two unequal images (strong image and temporal shadow) and in which both of these images are sent to one eye and both are sent to the other eye; i.e. they are contained within a single 2D image.

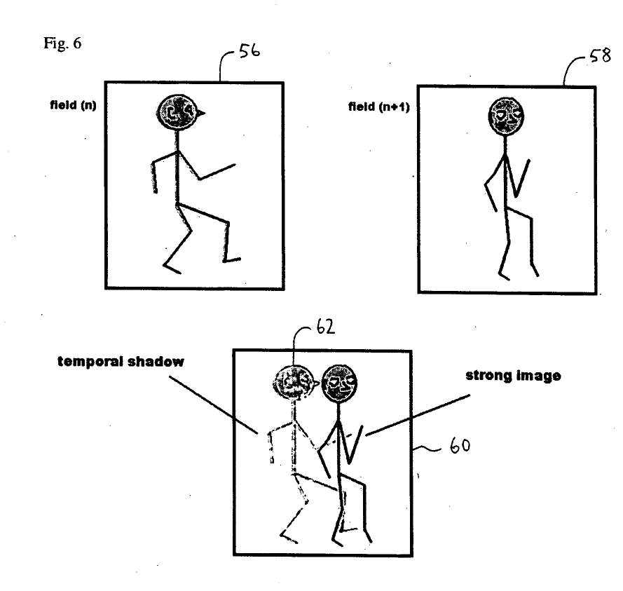

A strong image and a temporal shadow are combined in each single video field, and when we look at any sequence of successive video frames that have been processed in this way, and in particular look at the sequence of successive video fields within each frame, we see that the first field (the odd field) has a temporal shadow accompanying fast moving objects, so we can clearly see the strong image and the temporal shadow in such cases, and when we look at the next video field within the frame (the even field), we see that the temporal shadow is now in the position that the strong image was in before. Then, in the next field—the first (odd) field of the next frame—the temporal shadow is also in the position that the strong image was in—in the last (even) field of the preceding frame. And so it is as though there is a slight ‘after-image’—see FIG. 6, showing a first field (n), 56, a succeeding field (n+1) 58, and the processed version 60 of the second field 58 incorporating a temporal shadow 62 derived from the first field 56.

Those objects within an image that are moving at still greater speed have a greater distance between the strong image and the temporal shadow. The temporal shadow precedes the strong image (i.e. it is derived from the preceding field, in this example). As a result, the greater the speed of the object within the image, the greater its ‘displacement-footprint’ within the processed video field image.

Those objects within the image that are moving slowly have no separation between the strong image and the temporal shadow, and they almost share the same boundaries, with the temporal shadow image giving an additional edge, a slightly elongated or altered shape to the image.

As previously discussed, a first parameter (variable) that needs to be determined at the outset of this stage one processing is the degree of displacement that must be registered of each pixel, from one video field to next, before it is represented in the memory file and subsequently modified, before being added to the adjacent video field as the temporal shadow.

In other words: how fast must an object be moving before it is created as a temporal shadow in the following image, and how slow must an object be moving before it is not?

How the displacement parameter is set will depend upon the subject matter, and the intentions of the director of the work.

Throughout the description of this embodiment, all digital processing is on a field by field basis. Reference is made to frames because, in interlaced scan systems, fields are grouped into frames, but more generally the present system is applicable to discrete pictures that are arranged time sequentially, regardless of the format. In particular, references to fields in the context of interlaced video formats in the present embodiment will be understood to be generally applicable to frames in the context of non-interlaced formats.

As also discussed above, a second set of parameters/variables determines the state of the temporal shadow: the degree and character of its degradation and de-resolution, and the degree of its transparency when combined with the strong image (current/reference field/frame).

By varying the degree of displacement, and creating, for example, three different memory files for any two adjacent fields, with the first memory file containing all those pixels/objects that had moved a very small amount (slow moving), the third those pixels/objects that had moved a very great amount (very fast moving), and the second memory file containing all those pixels/objects that have moved an intermediate amount, then each file may have a different degree of degradation applied to it before it is reintegrated with the strong image. In this case there would, in effect, be a temporal shadow image composite, made up of pixels from the slow moving set that were only very slightly de-resolved (degraded), images from the second set that were de-resolved by an intermediate amount, and images from the third set that were heavily de-resolved. The degree of transparency applied in blending the elements of the composite shadow image would also be varied.

This temporal shadow composite applies particularly to complex scenes where very fast moving and very slow moving objects occupy the same scene. In such cases, the memory file for the very slow moving objects may be created by comparing pixel displacements over two or three fields and the transparency in the final image will be low, whereas the memory file for the very fast objects may be created by a pixel comparison over one field and its vagueness in the final image will be high. These two (or more) memory files are added together to create the temporal shadows that are subsequently blended to create the temporal shadow composite.

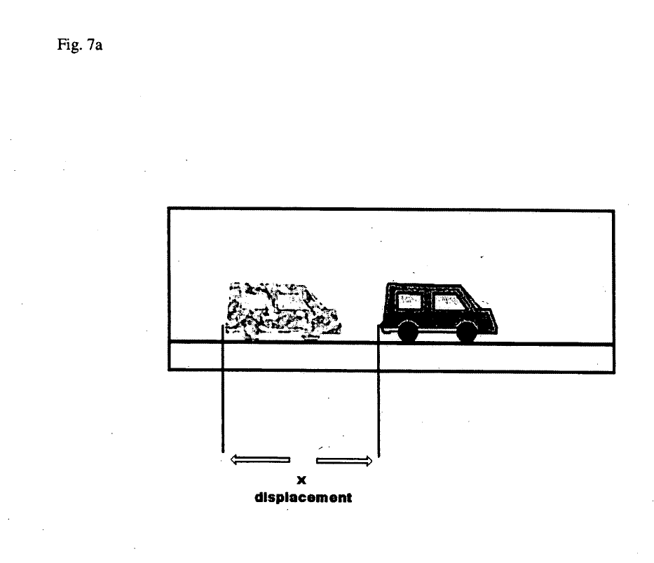

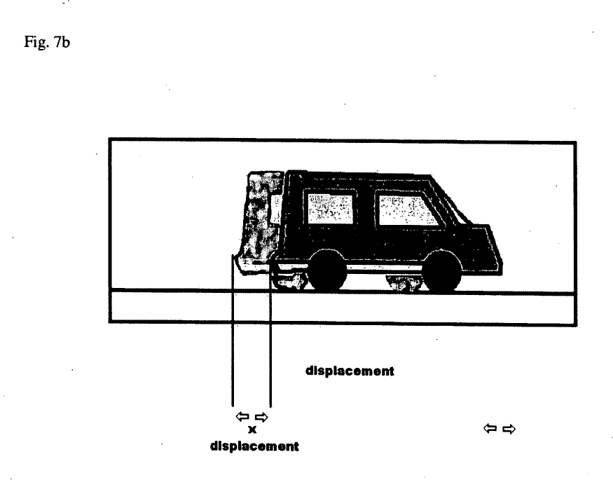

The greater the displacement in its position from one video field to the next, the more degraded is the temporal shadow rendered to be, and the less distinct and more transparent is its image in the video field (see FIG. 7a). Therefore the smaller the displacement footprint (see FIG. 7b), the more distinct is the outline and combined image (with the temporal shadow). But this is not always the case: in some settings, the degree of degradation may be small—i.e. the temporal shadow approximates the strong image in clarity—and this degree of degradation may be constant, regardless of the degree of displacement of the object from one field to the next.

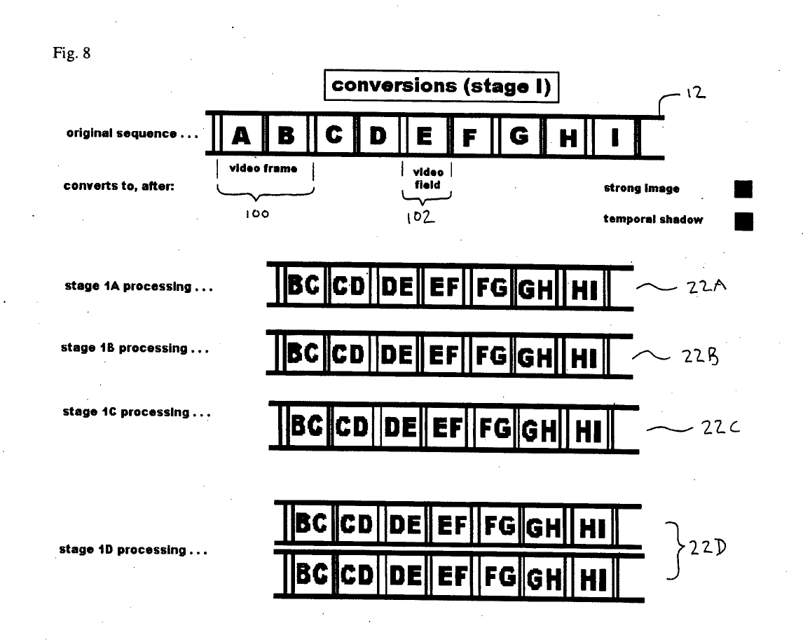

Having described the general principles and details of the stage one processing, and a number of possible variations thereof, there will now be described a number of basic options that may be employed within the stage one processing, referred to as Stage 1A, Stage 1B, etc. FIG. 8 provides an overview of these various options as applied to a video sequence 12, comprising a series of frames 100, each of which consists of two fields 102. The letters A-I represent the pictorial content of the individual fields. 22A-22D represent the result of processing according to stages 1A, 1B, 1C and 1D respectively, in which the black letters represent the content of the current field (strong image) and the grey letters indicate the fields that are the sources in the original video sequence 12 of the temporal shadows in the processed fields, as described in more detail below.

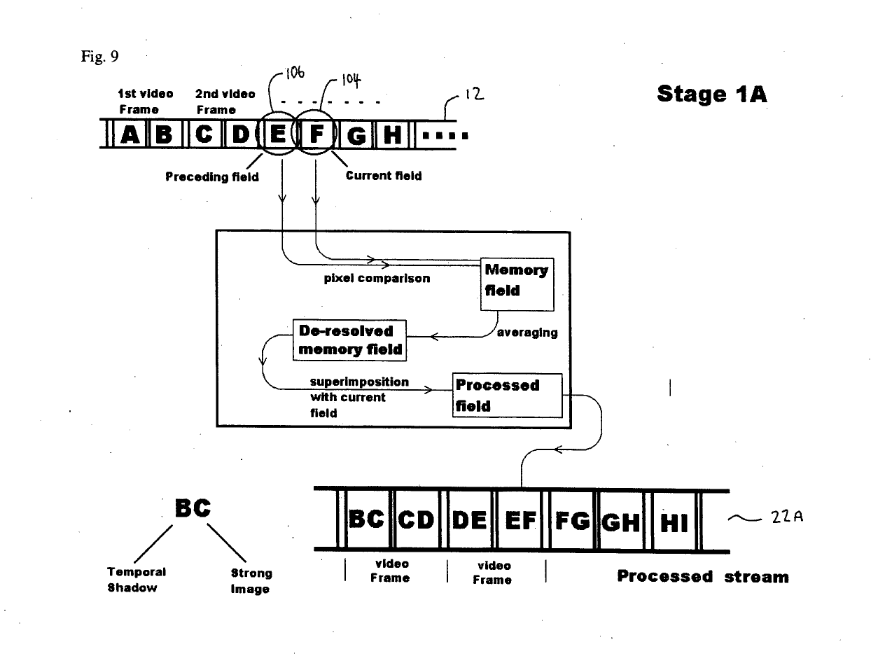

Stage 1A Processing (FIG. 9)

This option is based on temporal shadows for current fields 104 being derived from preceding fields 106. Apart from this order of the fields, all of the possible processing variations previously described are applicable as regards multiple/composite shadows, variation of the displacement, degradation and transparency parameters, etc. In the simplest case, a single temporal shadow for the current field is derived from the immediately preceding field on the basis of a single displacement parameter, a single degradation parameter and a single transparency value. In more complex cases, multiple/composite temporal shadows for the current field may be derived from one or more preceding fields on the basis of a multiple displacement, degradation and transparency parameters.

The output from stage 1A processing is a single channel of video fields in which all fields include temporal shadow content derived from preceding fields. The temporal shadows represent “where an object has been”, giving a sense of a motion trail.

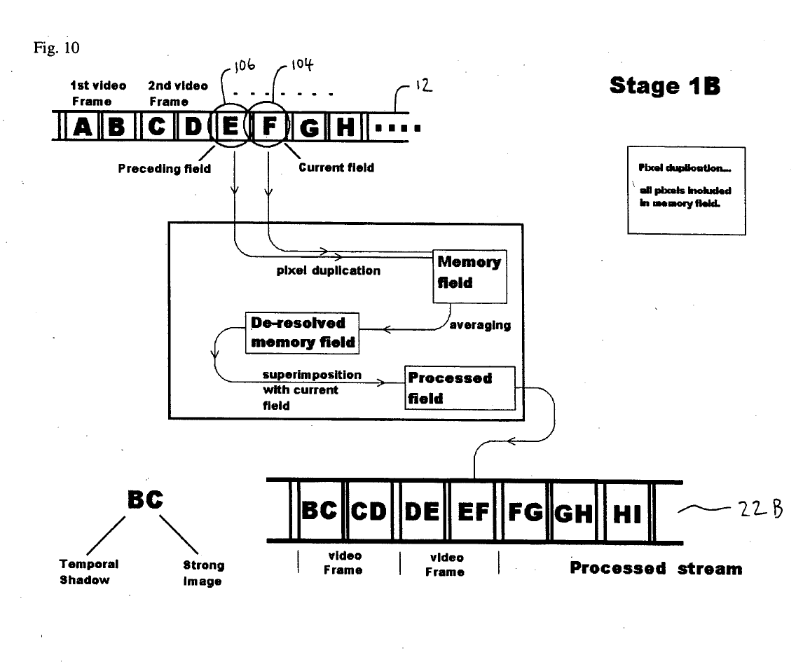

Stage 1B Processing (FIG. 10)

This is a special case of Stage 1A processing, in which the displacement parameter is set to zero, so that the temporal shadow for the current field is derived from the entire image from the preceding field.

The output from stage 1B processing is a single channel of video fields in which all fields comprise a composite of the current field and the temporal shadow content, comprising a degraded/partially transparent version of the whole content of the preceding field. Viewed on a field by field basis, fast moving objects have a discernible coloured shadow, with slower moving objects having a slightly coloured, granular edge.

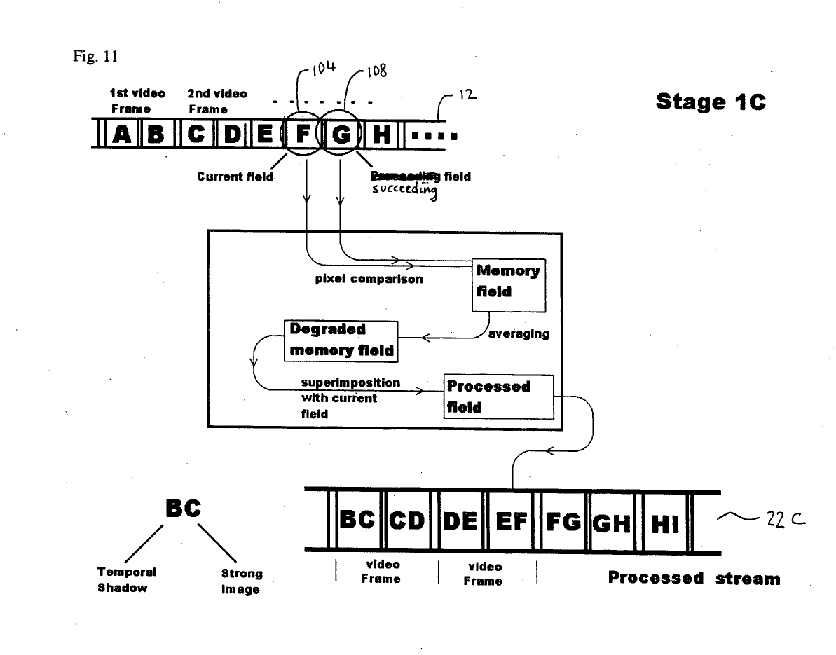

Stage 1C Processing (FIG. 11)

Stage 1C processing is the same as Stage 1A and/or 1B, except that the temporal shadows are derived from succeeding fields 108, rather than from preceding fields. Stage 1C processing can be accomplished in the same way as Stage 1A/B, by processing the videostream playing back in reverse, or by using the field stores 14 to create a sufficient buffer for processing the necessary fields.

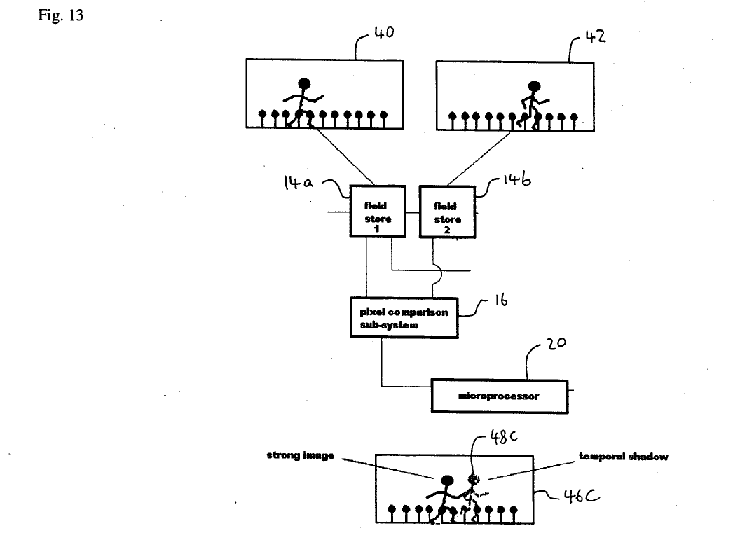

As a result when the processed sequence is played in the correct direction, each temporal shadow now matches the strong image of the preceding video field. This is illustrated in FIG. 13, as compared with FIG. 3. FIG. 3 shows processed field 46 corresponding to original field 42 and including temporal shadow 48 derived from preceding field 40, while FIG. 8 shows processed field 46C corresponding to original field 40 and including temporal shadow 48C derived from succeeding field 42.

In this case the temporal shadow “leads” the strong image on each frame. This creates a subtle difference over the processing in Stage 1A and 1B and depending upon the camera angle relative to the onscreen images, will produce a more satisfactory result. Stage 1C gives editors and directors the option of selecting a sub-algorithm whose end product (after stage 2) looks a more natural.

The output from stage 1C processing is a single channel of video fields in which all fields include temporal shadow content as in 1A or 1B, except that the temporal shadow content is derived from succeeding fields. The temporal shadows represent “where the object is going”.

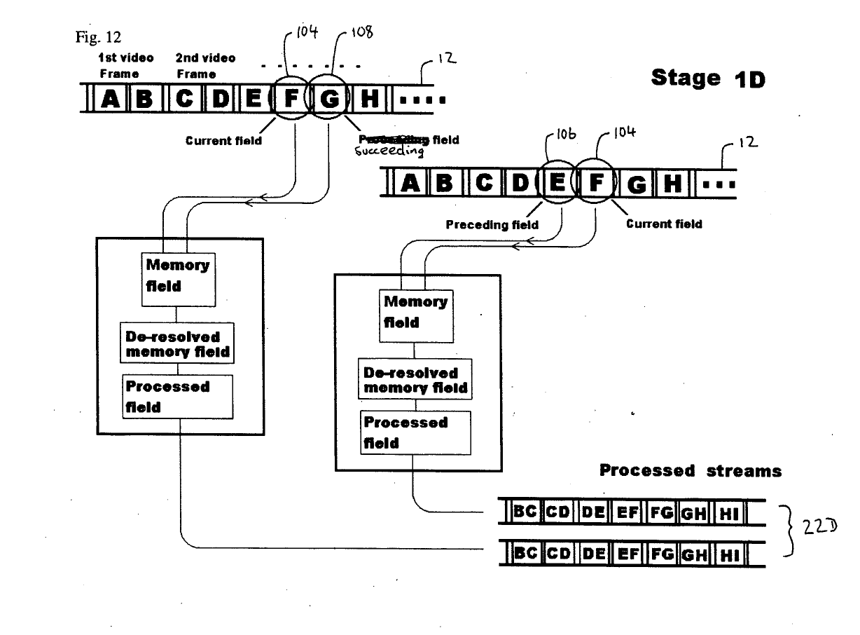

Stage 1D Processing (FIG. 12)

In Stage 1D processing, sub-algorithm 1A/1B (one or the other) is applied to one copy of the video sequence (this will become, e.g., the left eye view) and sub-algorithm 1C is applied to a second copy of the video sequence (this will become the right eye view). In this way each eye has the same strong image, but with the temporal shadows being from the preceding fields in one case and from the succeeding fields in the other.

Stage 1D, unlike sub-algorithms 1A, 1B, 1C, produces two, not one, streams of video, and although it is also subject to stage two processing, it does constitute a ‘gentle’ stand alone’ full 3D conversion algorithm on its own. However stage two processing applied to stage 1D greatly enhances the 3D effect.

The system architecture of FIG. 1 can easily be adapted for the purposes of stage 1D processing, either by the duplication or modification of the relevant components/modules, enabling two copies of the original 2D signal 12 to be processed in parallel, or by providing suitable storage means for storing a first copy of the output 2D signal 22 (being one of the two left and right hand channels output) while a second copy of the original signal 12 is produced (to provide the other channel). The input to stage two processing would then comprise first and second channels, so that the splitter/amplifier 24 would be redundant.

One other feature of stage one processing may be highlighted.

By increasing the displacement-footprint, which is now effectively the new image of every object that is moving above a certain speed (always relative to the camera), the degree of occlusion—the ‘overlap’ between these objects and those objects behind them, and therefore farther from the camera—is increased.

Those objects that are farther away are, in by far the majority of cases (but not always), moving at a slower velocity relative to the camera. As a result, the degree of overlap is increased and this, the degree of occlusion, is one of the key contributors to our understanding of the three dimensional world. So by increasing the degree of occlusion, we are adding further to the three dimensional depth cues that are present in a two-dimensional picture or video field (see FIG. 14, which provides a comparison between an original image 62 and the same image incorporating a temporal shadow 66 from a preceding field).

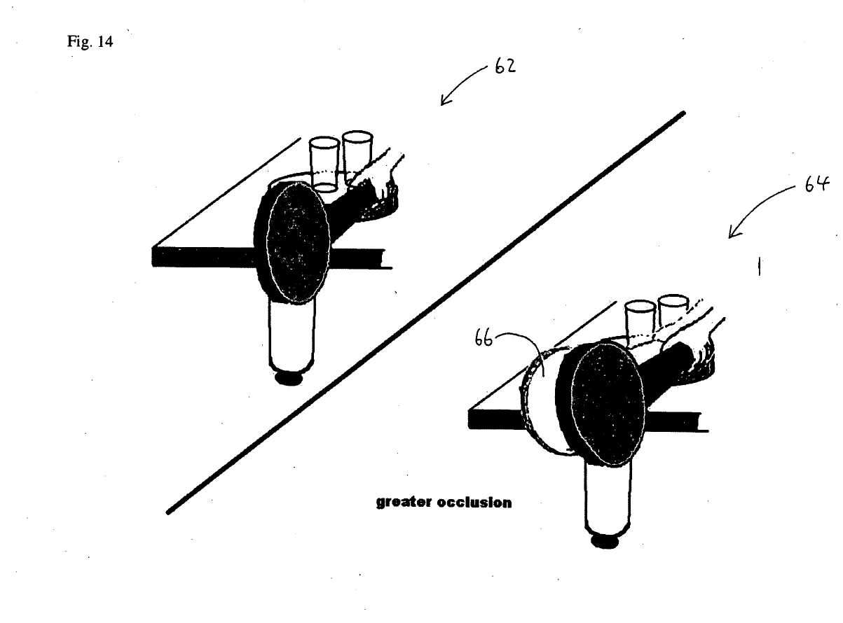

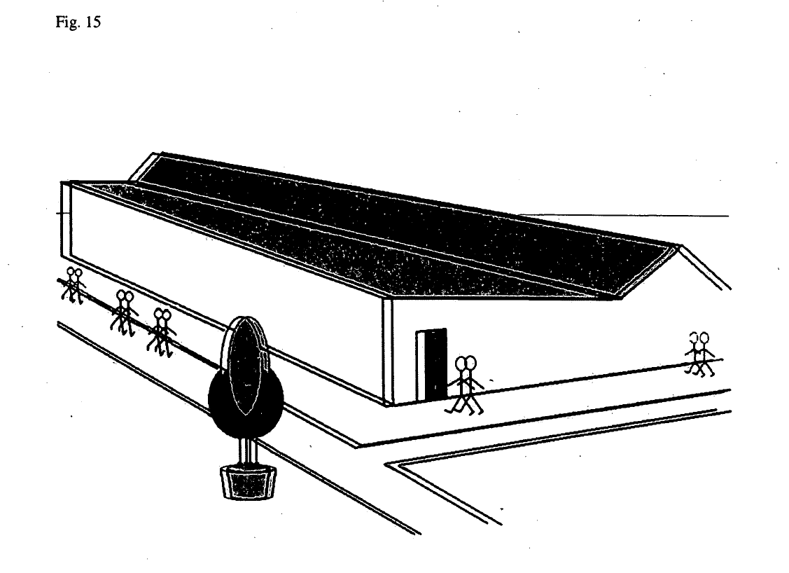

So the stage one processes 1A, 1B and 1C produce a modified two dimensional picture that has significant differences from the original. In one case we will have produced a picture that has a series of temporal shadows, visible at specific sites within the image (Stage 1A/C), and as just mentioned increasing the degree of occlusion; or in another case (Stage 1B/C) a “global” temporal shadow of varying ‘regional magnitude’ throughout and across the entire image as illustrated in FIG. 15.

Each processed image has—when viewed two-dimensionally—a slightly lower resolution than the original unprocessed image that it was derived from (in fact each processed image is derived from at least two original unprocessed images), but it does have additional information. The resolution loss is not due to ‘noise’, and when viewed three-dimensionally the added information results in the viewer receiving cognitively a much higher resolution, since three-dimensional pictures always contain much more cognitive information than two-dimensional equivalents.

Stage one processing introduces additional three-dimensional information into a flat, two-dimensional image. Stage two processing ‘unlocks’ this information to present it stereoscopically.

Stage Two Processing.

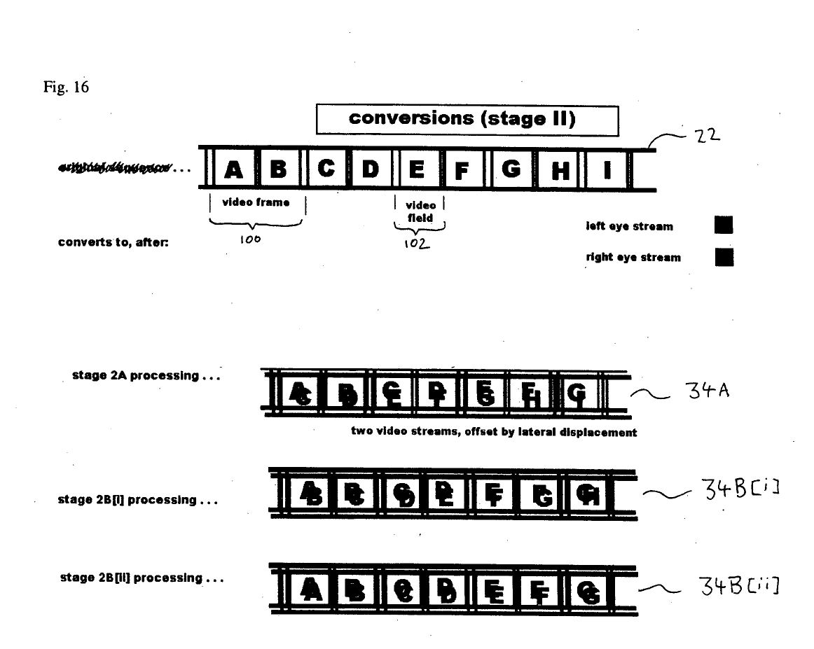

As previously described with reference to FIG. 1, stage two takes the enhanced signal 22 as input to a splitter and amplifier module 24, which outputs two identical copies of the enhanced signal 22 (or else, in the case of 1D processing, two differently modified videostreams provide the input to stage two as described above). There are several options for stage two processing, as shall now be described. FIG. 16 provides an overview of stage 2 options 2A, 2B[i] and 2B[ii]. The following description assumes a single channel enhanced 2D signal 22 is input to stage two (i.e. the sequence 22 in FIG. 16 represents the output from any one of stages 1A-1C; the letters A-I in this case represent the pictorial content of the stage 1 processed video fields, including the temporal shadow content). Essentially the same processing may be applied to the dual-channel signal provided by stage 1D processing. 34A, 34B[i] and 34B[ii] represent the outputs from options 2A, 2B[i] and 2B[ii] respectively with the black sequence representing one stereoscopic channel (e.g. the left eye channel) and the grey sequence representing the other channel (e.g. the left eye channel).

Any of the stage two processing options may be applied to the output 22 from any of the stage one processing options.

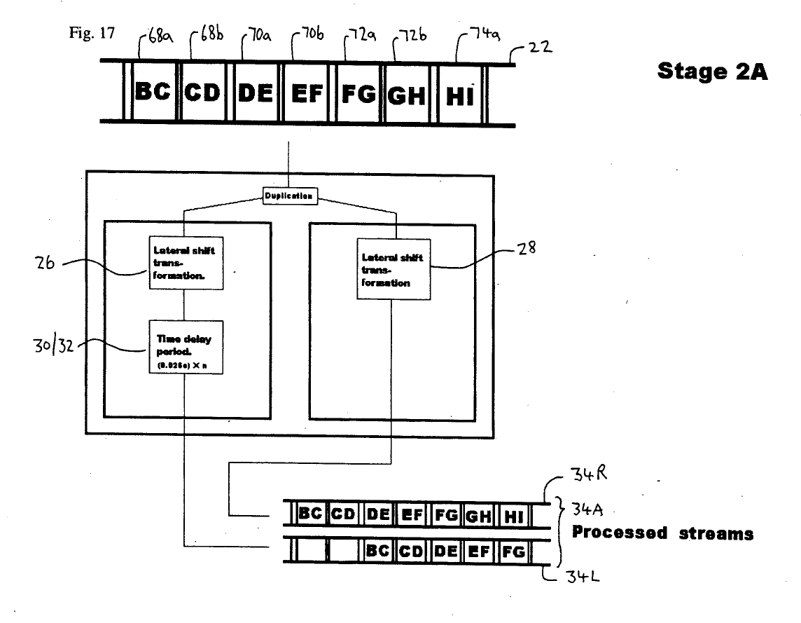

Stage 2A Processing (FIG. 17)

The processed video sequence (enhanced 2D signal) 22 of FIG. 1 is illustrated as a sequence of fields 68a, 68b, 70a, 70b, etc. (each pair of fields 68a/b, 70a/b etc. corresponding to one complete image frame). The original strong image and the temporal shadow content of each field is represented schematically by the black and grey letters in each field.

Stage 2A processing involves splitting 24 the processed video sequence 22 into two identical streams of images, and introducing a lateral shift (in the horizontal (x) axis) 26, 28, so that they are displaced relative to each other, by an amount of between 2% and 10% of their overall width. The output 3D signal 34 comprises first and second channels 34R, 34L (the relative lateral shift in the content of corresponding fields of the two streams is not illustrated here).

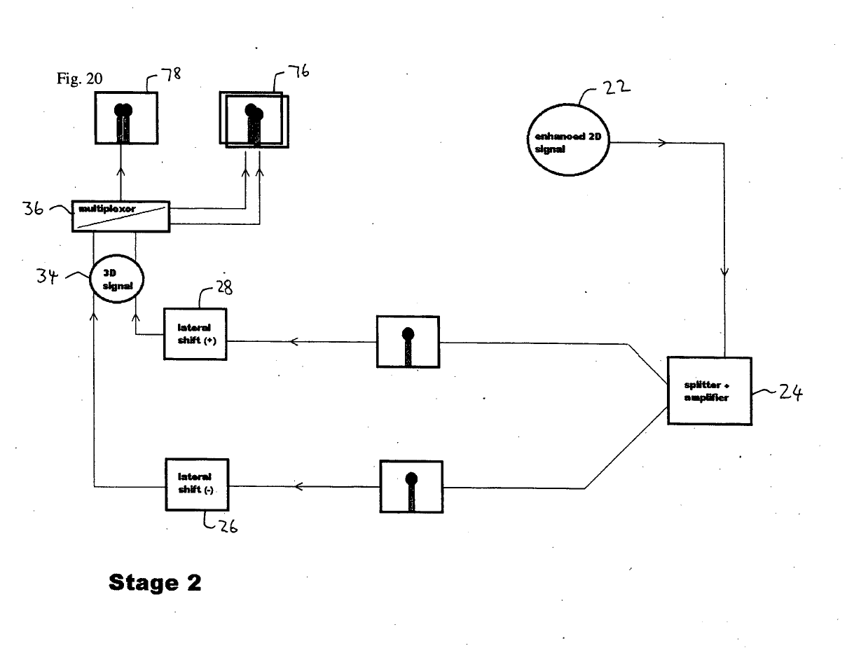

As shown in FIG. 20, the output can be switched between a two channel mode 76—in which each eye view is intended to be played back separately, e.g. by a dual-projector system—and a single channel mode 78 in which both channels are multiplexed 36 to interleave each channel, by taking every other field from each channel and joining them sequentially. The resulting single channel can be broadcast or stored and played from DVD or any other suitable storage medium, with the viewer needing, for example, electronic timed-shutter glasses synchronized with the images (e.g. LCD glasses), or equivalent autostereoscopic (“glasses free”) display technology to watch the image.

If we consider a common displacement—common for this process—of 5% of the overall width, then each image in the two streams, is displaced laterally by 2.5% of the overall width but always in opposite directions to each other.

In different processing, the images are either

(a) displaced towards the opposing eye (this means that the right eye image is moved laterally towards the left, and the left eye image is moved towards the right)—this is a negative displacement (in extreme cases it can cause the eyes to cross) and can cause the final stereoscopic image to progress from the plane of the display medium (TV, LCD) towards the viewer, or

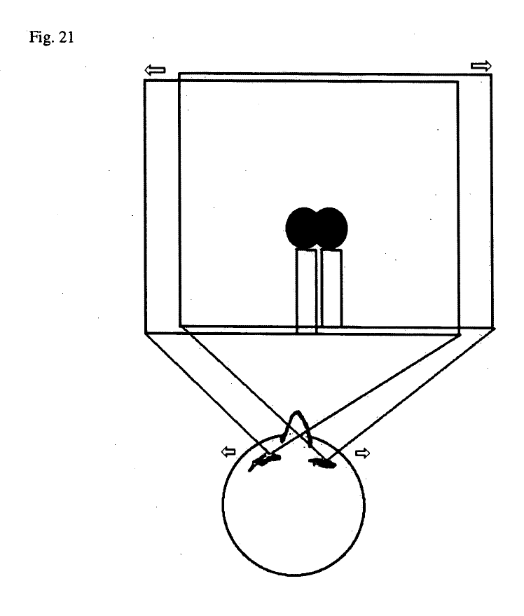

(b) displaced in the direction of the viewing eye (see FIG. 21)—this is positive displacement and causes the images to regress from the plane of the display medium (CRT, projection screen, LCD) away from the viewer.

In addition to creating identical streams and then introducing a lateral offset as described, Stage 2A processing also introduces a variable time delay between the two streams, as illustrated in FIG. 17. It will be seen that the field stores 30 and video bus 32 of FIG. 1 are used to delay one channel relative to the other; as seen in FIG. 17, this delay may be introduced after the lateral shift process, rather than before as shown in FIG. 1. Usually this delay period is between one video frame duration time delay (one video frame has the same time period as two video fields) and up to three video frames duration time delay (six video fields), depending upon the image content and the intentions of the director. Usually, one video frame to two video frames (two to four fields), is the time interval between the two streams. However, in special cases, three video frames (six video fields) time delays are employed, this would typically be for extremely slow moving scenes, involving landscapes and distant objects, or very slow, slow-motion sequences, and slow moving machinery.

It can be seen that the time delay selected also determines, at least in part, the relative delay between the temporal shadow present in an image in one channel and the corresponding copy of the image from which the temporal shadow was derived in the other channel.

The upper limit on the time delay that may be used is quite subjective and depends largely on the content of the motion picture sequence. It is envisaged that delays of up to five frames might yield desirable or acceptable results. By extension, this also means that the copy of the original image in one channel from which a temporal shadow in an image in the other channel is derived may be displaced in time by up to five frames.

One difference between this and other time parallax 3D conversion systems, is that the time differences over at least two video fields—and up to six video fields, are represented within a single video field.

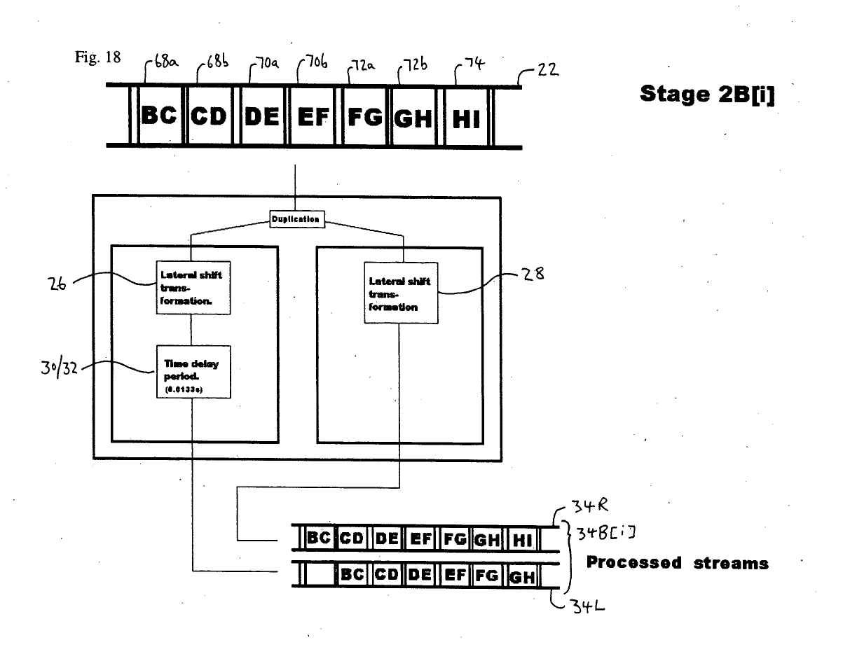

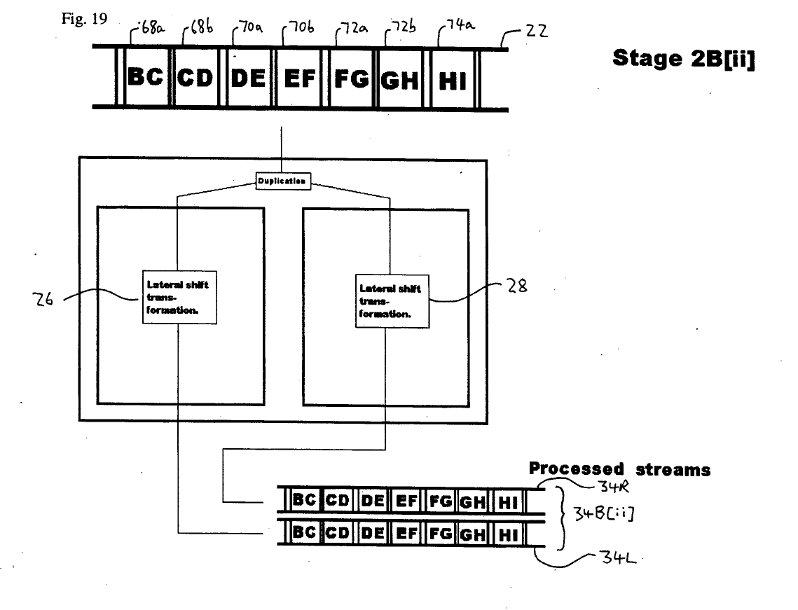

Stage 2B Processing (FIGS. 18 and 19)

A further special case of stage two processing involves using either:

[i] a single video field time delay introduced between the two video channels (stage 2B[i]).

[ii] no time delay introduced between the two video channels: they are run in sync.

In both cases the lateral displacement is still introduced.

This special case stage two processing (stage 2B) has been found by the inventor to be very successful, for reasons that will now be explained.

Analysis of Stage 2B Processing

In stage 2B, in both cases ([i] a single video field delay, and [ii] no delay), the image that each eye receives now has a far greater component of the same information that the opposing eye is receiving, so there is a greater degree of balance between the two images (left eye/right eye).

Looking at case 2B[ii], first, in the case of no time delay, each eye is now receiving images that although laterally displaced, are identical—there is no rotational parallax between the images. When considered purely in stereoscopic terms, this should not give a satisfying 3D image—it should merely create a window effect.

However it does give a satisfying 3D effect, and when analysed through a broad neurological model of cognition, the reason for this can be understood. The two near identical images are combined by the brain in such a way that allows the brain to consider the resultant image as though one eye had received the temporal shadow and other eye had received the strong image.

When the left eye and right eye, see an image. At some location within the visual cortex both of these images are represented separately, but at an all important higher level of visual perception and at a further specific region within the cortex, they are combined and the differences measured and understood as one item: the position relative to the viewer, which is how we “understand” (not “see”, but “understand”) stereoscopic images, that is to say, understand the meaning of a stereoscopic image over a two-dimensional one.

Although as stated there is in this case no rotational parallax between the two (left eye and right eye) images, there is rotational parallax within both frames between the strong image and the temporal shadow.

An experiment performed by the present inventor involved sending a full colour image of a scene to the left eye, whilst sending a monochrome version of the same image to the right eye. In the resulting image as perceived, colour was seen, but diluted colour, as if the degree of colour had been spread over both inputs. In other words, the specific colour saturation appeared divided in half, diluted through being shared between both eyes. What was most significant was that at no time—with either full motion sequences or still images—did the brain reveal which eye was receiving which stream: colour or monochrome.

When the streams were switched, so that the right eye now received the full colour image and the left eye received the black and white image, the result was the same and once again at no point did the brain detect which eye was receiving which video stream, colour or black and white.

This experimental result is considered by the present inventor to be significant, and is offered here in support for the model behind the processing provided by the present invention.

Extrapolating from that result, the present inventor postulates that even had the image streams been switched whilst the viewer was watching—e.g. from colour left eye and black and white right eye, to the reverse—the brain would not have been alerted to the nature of the change—even if the transition itself was subliminally detected. Even if switched in mid-viewing the brain would still be unable to detect which eye was receiving which image stream: colour or black and white.

The inventor further postulates that if, in an experiment with special viewing glasses, a three dimensional stereo image stream, was suddenly switched so that without the viewer's eyes needing to realign or in any way change their orientation, the perspective of the images fed to both eyes was suddenly reversed, with the right eye now receiving what had previously been received by the left eye (namely a more leftward view), the brain would still generate for the viewer a full correct stereoscopic image with no sense of the paradox of seeing a more leftward rotated image with the left eye, and with no sense of a paradox being generated by the brain.

The reason for this, as is the case of the colour and black and white image reversal, is that the higher mammalian brain has experienced at no time in its millions of years of development history, any evolutionary pressure, to develop the ability to discriminate between the left eye and right eye.

Images from the right eye show the brain more information on the right side of the body and the brain responds to this information accordingly.

Further, because the brain understands left from right—which always means more leftward or more rightward relative to its sense of its position within its worldview, a sense of position that is its placement of the central axis of the body within the midst of this worldview (which is a centrally important item of information for the brain, generated by a highly complex set of neurological and cognitive processes that begin forming at a post-natal phase and become established during early childhood deep within the cerebral cortex)—and these neurological and cognitive processes underpin much visual processing that goes on throughout life—and because of this deep rooted understanding of left and right, whether the right side view comes into the brain via the right optic nerve or via the left, the brain will not be prevented from coming to ‘understand’ that this view is to be found on the right side of its central axis; i.e. on the right side of the body.

In modern day computing terms, it is as though the optical data is imported into a ‘position determination’ application and outputted as a visual understanding file, with the specific domain that is the source of the optical data not being relevant.

This is because in nature and throughout the millions of years of development, the optic nerves have never suddenly switched over, and so the importance of which eye sees which view did not become important. The right eye has always seen the more rightward views, and more importantly, objects with a more rightward perspective could always be reached more easily with the right hand or limb and were closer to the right side of the body. Consequently this is the level of processing and understanding that is necessary.

The processing provided by the present invention is also effective for a further very fundamental reason.

It is often the case that in on-screen movement, those elements that have the least motion from frame to frame are those elements that are at the centre of the frame, and hence at the centre of the viewer's field of focus, and most importantly, are at the centre of the cognitive significance and the meaning of the frame or sequence of frames. Therefore, in life, such elements will be at the centre of the image directed onto one's retina.

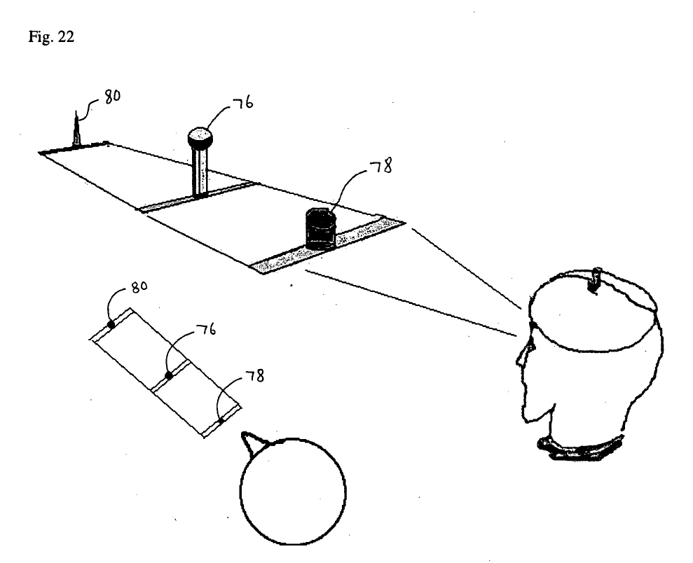

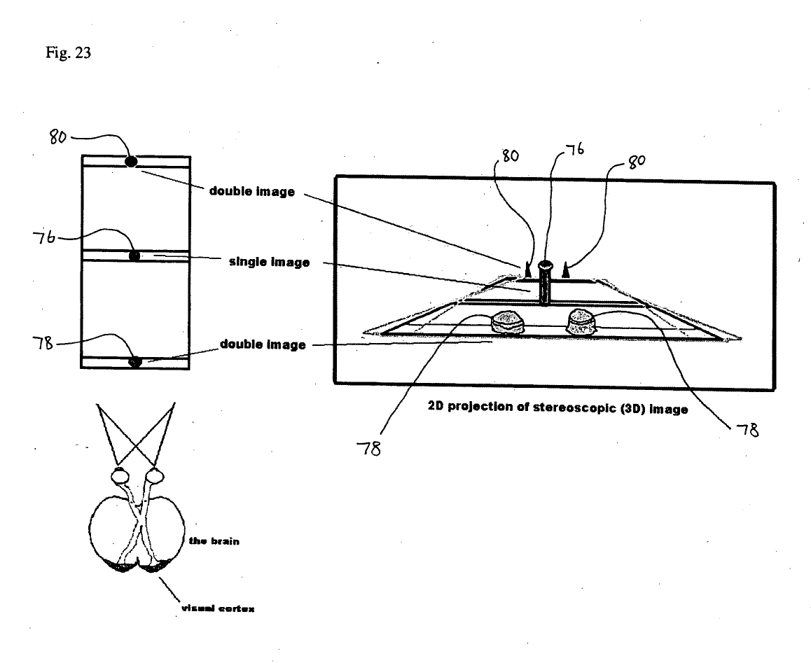

Analysing the brain's received representation of a simple three dimensional scene (see FIG. 22), assuming that at first the brain directs its attention to an object 76 at the centre of the scene, this then causes both eyes to align on the central object 76. As a result, the image that the brain receives—the image that means “this scene has depth”—actually requires that the brain sees two images for the nearest object 78 and two images for the farthermost object 80 (see FIG. 23).

When the brain directs its attention to the nearest object 78 the other two objects 76, 80 and all other lines and objects will be seen as double images but by varying degrees, and the same also occurs when the brain directs its attention to the farthermost object 80.

It is important to note that a 3D picture for the brain is actually a 2D projection of a three dimensional object or of a scenes with various objects, as seen from two separate positions, and as such at only one area within such a 2D projection will the images be singular. At all other regions within the image—the 2D projection, they will be double images.

The present inventor believes that this is why the present process is so effective. The inclusion of temporal shadows as described herein provides a very close approximation of this 2D projection. Those objects that are slow moving or are at the centre of frame will have very little displacement between the temporal shadow and the strong image, and will appear as a single image, while those farther from the camera and faster moving will have a greater displacement between the temporal shadow and the strong image. As such the processing provided by the present invention allows those objects at the centre of attention to be singular or close to singular images, whilst those closer and farther away will be double images.

The present processes—producing images that contain double images—take us closer to the reality of 3D which is to be found in a “real” 2D projection of a three dimensional scene, as seen from two perspectives.

As a consequence, when the brain receives the two images combined into one in the form of a temporal shadow and a strong image, particularly when combined with the important physical cue that the brain receives because both images have been laterally displaced (the eyes record an actual angle of realignment change when looking from the framing edge of the picture to the picture within the frame, and then back again—which gives this physical cue), the brain interprets the combined image that it now receives jointly from both eyes as being the image that it itself has generated after it has combined the images from the two distinct images received separately from both eyes. As a result, the brain generates a stereoscopic image with a strong sense of depth and clarity, because it receives these depth cues (rotational parallax and lateral displacement), and the final stereo pair image is now in greater balance between the eyes.

The further special case also of 2B[i] (a single video field delay) provides a hybrid between the cognitive 3D model as just described in the null delay case, and the rotational parallax model.

Although most films are recorded at between 24 and 30 frames a second, video fields are displayed at 60 fields a second. To accommodate this difference every second video field (the even field numbered fields) in a video frame shows the same picture as its predecessor (the odd numbered video fields). So in such cases each video field image is repeated.

However after Stage 1 processing, each video field is unique and now has a difference from the preceding and successive video fields—even when derived from 24 to 30 frames a second original film material. So the odd (numbered) video fields are no longer repeated exactly as the even (numbered) video fields. FIG. 16 shows the repeated field of standard (24 frames per second) celluloid film converted to video on the left side of the illustration. On the right side is shown how the processing produces two unique fields for each frame.

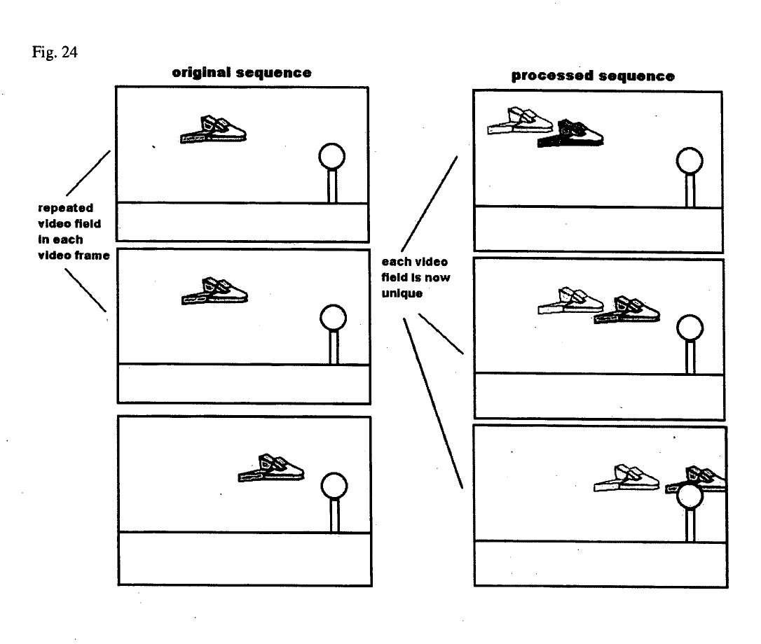

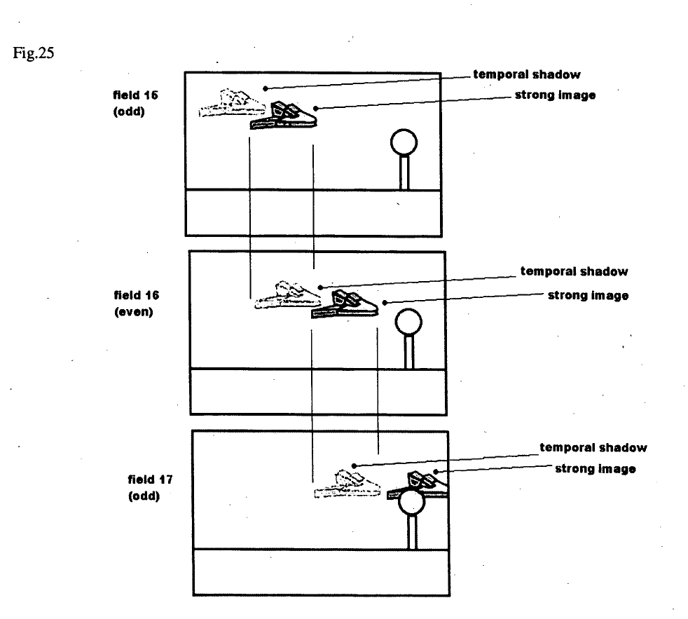

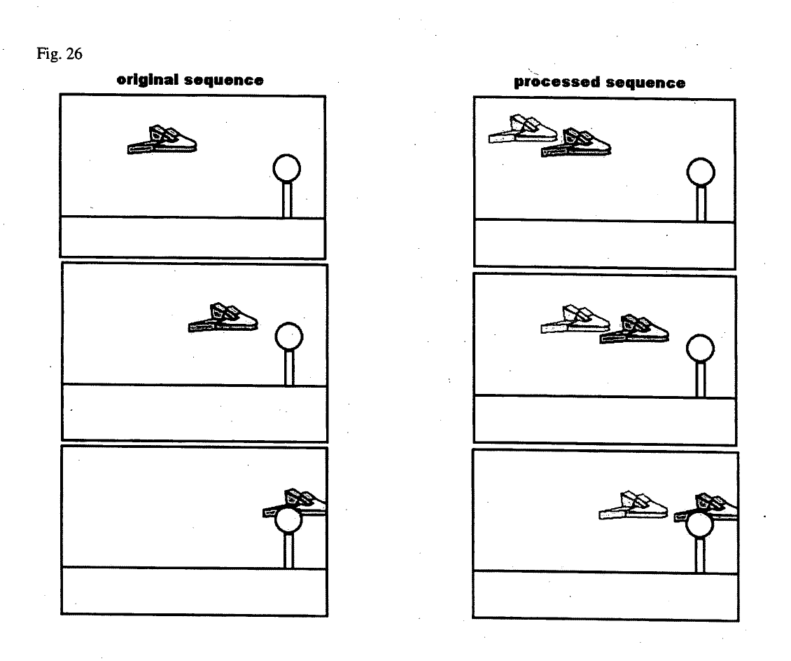

The temporal shadow of the odd field always matches the strong image of the even field, and the odd field's strong image always matches the temporal shadow of the even field in the following video frame, and so it goes on, with the even field always matching its temporal shadow with the strong image of the odd field ahead, and the even field's strong image always matching with the temporal shadow of the even field just behind it (See FIG. 24). In FIG. 25, it can be seen that each frame and field, at the end of stage one processing, has been turned into a different frame and field incorporating information from at least two fields.

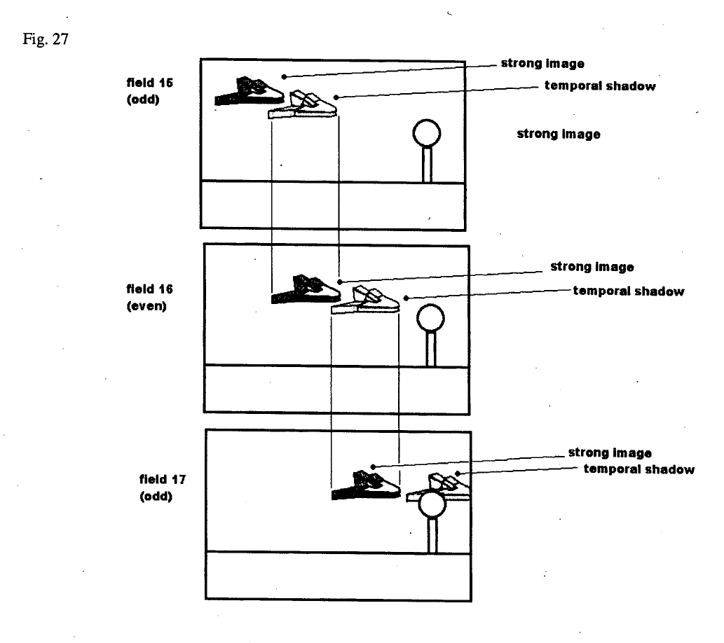

The temporal shadow is always where the strong image has just been—it is its previous position. It is older positionally and therefore it lags behind the strong image when they are viewed together in the combined field. An exception to this is in stage 1C processing. In that case the temporal shadow is where the strong image is going—it is in an advanced position, the future position of the strong image. (See FIG. 27). If we compare and contrast FIGS. 25 and 27, it can be seen that they represent the output from sub-algorithms 1A (or 1B) and 1C respectively.

This means that when a single video field delay is introduced, there is a little more rotational parallax contained in each stereo pair beforehand, because there is already rotational parallax between the temporal shadow and the strong image within each video field, but now there will also be additional rotational parallax between the fields in each of the two video streams going one to the left eye and the other to the right eye, on account of the single field delay that has been introduced between the left and right video channels.

The strong image from the odd field now maps onto the temporal shadow from the even field, with the lateral displacement giving a sense of position, and the temporal shadow from the odd field and the strong image from the even field create an even greater sense of depth because the degree of rotation is now increased. These two fields contain information from three fields.

This means that a greater sense of stereoscopic depth can be generated, but at the expense of the images being less well balanced between each eye.

In both these cases, Stage 2B([i] and [ii]), the balance of the images between the eyes is greater than is the case of the other delay intervals mentioned earlier (up to six video fields), and as result the image is easier to resolve.

This optical balance is very important. When looking at a 3D screen, a viewer ordinarily sits facing the screen face on, and this means that the brain is expecting a view with a degree of symmetry between the eye views. Therefore, any object within the overall image that the brain then focuses upon can be easily resolved if there is greater symmetry within the frame and around the particular object.

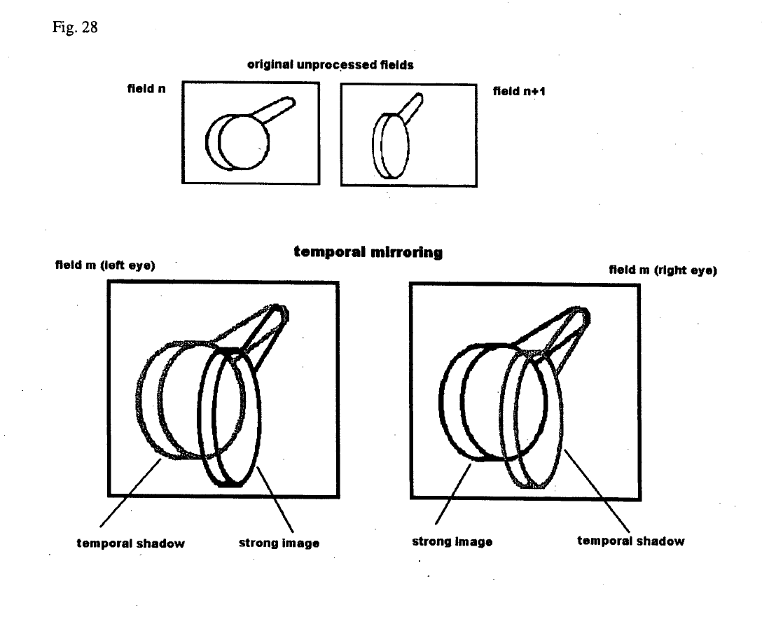

When Stage 2B[i] (single video field delay), and Stage 2B[ii] (no delay) are applied to stage 1D processing (where one channel has temporal shadows derived from preceding fields and the other channel has temporal shadows derived from succeeding frames), then in the case of 2B[ii] (no delay), there is now an even greater symmetry between the stereo pair: there is a “temporal mirroring” (a “mirroring through time”) because the left eye stream—which has temporal shadows from preceding frames—has a rotational parallax going in one direction (the direction of original movement), and the right eye stream—which has temporal shadows from succeeding frames—has a rotational parallax going in the opposite direction (see FIG. 28).

As a result, the rotational parallax present in each field is in the opposite direction to the rotational parallax presented to the other eye at a corresponding field. The direction of the rotation is given by the relationship between the strong image and the temporal shadow.

This temporal mirroring comes very close to simulating the relationship that each eye has with any object in the field of view. The displacement footprint of each object that is in motion will be different for each eye (see FIG. 28). And so, unlike the processing produced by stage 1B followed by stage 2B[ii] (no delay, corresponding to FIG. 11a)—where we have a neuro-cognitive model in which the brain interprets overwhelmingly similar but not quite identical (on account of lateral displacement) left and right eye image streams, as being significantly different left eye and right eye image streams—here in this processing of stage 1D followed by stage 2B[i] (single field delay) we have two genuinely different left eye and right eye image streams, and these produce a sense of 3D by the classical model of stereoscopy.

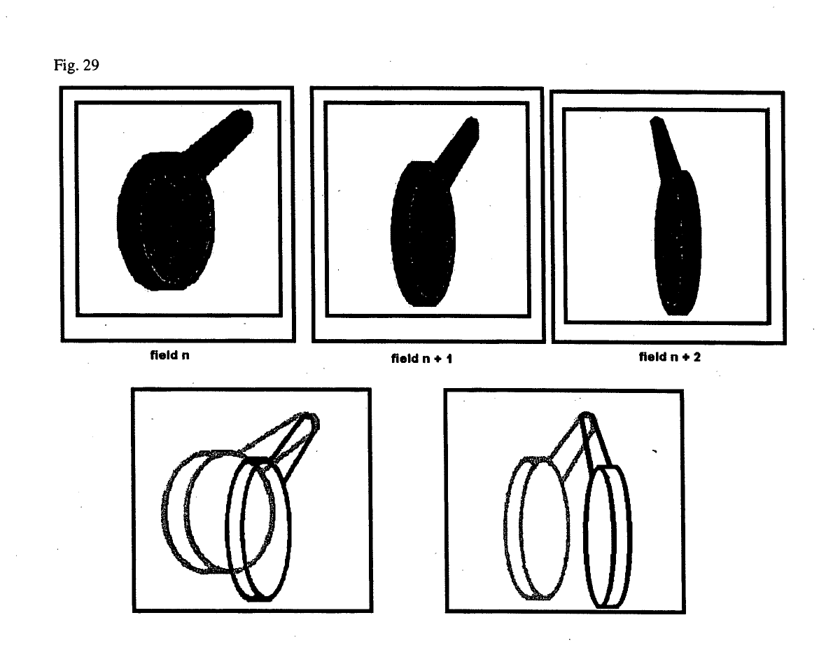

Also in the case of 1D/2B[i], we have an increased rotational parallax, as the two video fields in the left and right eye streams have information from three video fields (see FIG. 29). This may however be at the expense of the high degree of symmetry obtained by comparison using 1A/2B[ii] and 1B/2B[ii], but, as mentioned, there is an increased rotational parallax, and because the temporal shadow precedes the strong image in both fields (left eye stream and right eye stream), there is also a cognitive symmetry.

Stated differently, in 1D/2B[ii] we have “temporal mirroring”, and in 1B/2B[ii] we have “footprint mirroring”.

1D/2B[ii]) processing employs aspects from both the classical stereoscopic model and the present psycho-cognitive model. The left eye streams and right eye streams are largely identical (as before—minus the lateral shift), with the profile of the displacement footprint mapping exactly the one onto the other for each eye, but when analysed the left eye image has, within its displacement footprint profile for each object, an inverted relationship for the relative position of the temporal shadow and the strong image, as compared with the right eye image. So both models of 3D stereo perception (classical and cognitive) may well be at work when the brain is analysing image sequences from this processing.

In view of the significance attached to the psycho-cognitive model described above in relation to the present invention, the theory will now be recapitulated.

The rotational parallax which is at the heart of natural stereo vision and all photo-stereoscopy, and which is normally represented by the differences contained between the two images that are the two eye views, is now, in the motion picture sequences provided by the present invention, contained in each single eve view, through being represented by the combination of the temporal shadow and the strong image, and this combination is the displacement footprint created for every object found in each single eye view.

Objects are now replaced by their displacement footprints: each processed video field image is now the collection of the full set of displacement footprints.

As postulated here, because the brain has not developed neuro-cognitive procedures for detecting which specific eye is responsible for each of the two images, when the images arrive at the higher visual cortex sites, where the differences between the two eye images are compared and understood, the four images (two temporal shadows and two strong images) are “understood” (by the receiving region of the cerebral cortex—the site of processing) as being in fact two images, one coming from each eye—and are interpreted accordingly.

The brain partially interprets the combined two images (combined on the display screen in each displacement footprint), as having been seen by both eyes separately—as though they have travelled separately along each optic nerve, even though they were presented before both eyes and travelled up both optic nerves as a combined image. The combined image at the outset of the journey—as presented to each eye—imitates the combined image created in the higher centres of the brain at the conclusion of the journey, in the neo-cortex: the cortex sites that generate perception. And in this case the perception is of two separate images being combined to generate a 3D reality.

As a result each eye is balanced with the opposing eye. The difference between the two eyes is usually a problem with many examples of stereoscopic imaging, with many attempts made to both create the differences (the stereo differences) and minimize them at the same time. In the present approach the eye never experiences an excessive effect: negative or positive parallax. There is now only a lateral shift difference, but a satisfying appreciation of depth comes about because the rotational parallax is “seen” at the higher cognitive level necessary (the aforementioned “sites”) because the difference within the image seen by both eyes, is perceived as the difference between the images seen by each eye.

To further underline this point, consider the earlier described experiment in which each eye received either a full colour or black and white image. Suppose that a further layer of complexity is added to the experiment: instead of one eye receiving an image in colour and the other eye receiving black and white, we had one eye receiving a view in which 50% of the objects and part of the background was in black and white, and the other 50% of the objects and the rest of the background was in colour, and the other eye received the same image, but the situation was reversed so that the 50% that had been in colour would now be in black and white.

The present inventor again postulates that the brain would generate an image that had just one colour saturation level across the entire view—everything would be in colour, and all objects would be colour to the same degree: a mid-point saturation level.

This shows us that we do not in fact see what is in front of both eyes, when we view things stereoscopically. What we “see” is an “understanding” that the brain generates when it has compared both eye views, and updated our world view accordingly. And because these four images are coming into the brain and are changing sixty times a second, they have a subliminal presence and not a fixed position. As a result, when the brain tries to generate an understanding of these four rapidly changing image combinations, it finds the most likely (and most satisfying) explanation to be that there are in fact two images, one seen by one eye and the other seen by the other. The reason that we do not just simply show one image to one eye and the other to the other (in other words why we do not just show the strong image to one eye and the temporal shadow to the other eye), is because the stereo imbalance between them is sufficient to be significant and distracting.

The difference introduced by a frame delay, creates rotational parallax, but the stereo difference is often at the expense of stereo balance. There is a requirement for a high degree of equivalence between the eyes, and when the brain becomes increasingly aware of a lack of symmetry and equivalence, this awareness can outweigh the increased satisfaction occasioned by the stereo effect generated by rotational parallax.

By presenting rotational parallax, within each eye stream, and repeating the image exactly (with the addition of the depth framing caused by the lateral displacement) for each eye, the brain's requirement for optical symmetry and balance at the level of coarse filtering of visual data input streams is allowed to be met. Importantly, this also allows for the significant differences introduced by rotational parallax, to be understood as having been seen by both eyes, separately.

Variations and Modifications

The use of temporal shadows to provide additional 3D cues in stereoscopic motion picture sequences has been described thus far with particular reference to the conversion of an original 2D sequence to provide a pseudo-stereoscopic sequence. In the described embodiment, the temporal shadow for each image in the sequence was derived from images that precede or succeed the current frame. The effect of this, in the final two-channel stereoscopic sequence, is that the temporal shadow information contained an any image of the right eye sequence can be said to be derived either from the left eye version of either the same image or from the left eye version of an image that precedes or succeeds the current right eye image by up to a few frames (or fields). That is, it is the fact that the temporal shadow information is “derived” from the other channel that is important, and not the fact that the shadows are displace in time sequence.

It can be seen then, firstly, that in the case of pseudo-stereoscopic (time parallax) conversion, rather than processing the original 2D sequence to create the temporal shadows in each frame prior to duplicating the modified 2D sequence and applying whatever lateral displacements and time shifting is required, the original 2D sequence could be duplicated first, and the duplicated copies processed to derive the temporal shadows. In this way it can be seen more explicitly how the temporal shadows for one channel are related to the frames of the other channel. In this case it can also be seen that the temporal shadows could be derived from comparison of frames from different channels, and that this comparison could be done either before or after any time shifting or lateral displacement of the frames of one channel relative to the frames of the other.

Secondly, it will also be seen how the use of “temporal shadows” could be applied to any kind of otherwise conventional stereoscopic motion picture sequences. Given an existing stereoscopic sequence (e.g. a sequence shot using genuine stereoscopic cinematography, or generated by CGI techniques), temporal shadows could be added to the images of each channel either on the basis of comparisons between images in one channel with images in the other channel, or on the basis of the comparison of preceding/succeeding images from the same channel. Where comparisons are made between channels, frames of one channel may be compared with those frames from the other channel that are matched exactly in the time sequence or with frames from the other channel that precede or succeed the “reference” frames. Where an original stereoscopic sequence is generated digitally from computer data such as a 3D model or motion capture data, the temporal shadow image data could be computed directly at the time of synthesising the basic stereoscopic images.

In all these cases, the same or analogous considerations would apply as regards displacement, degradation and transparency parameters applied in generating the temporal shadows.

Since the final visual effects produced by the present invention are highly subjective in nature, precise limits on the manner in which the temporal shadows are generated and blended or the parameters applied in doing so are not appropriate and may be determined empirically, for practical purposes, on the basis of the present teaching.

Given the present teaching, suitable data processing techniques for the implementation of the techniques described can be seen to be within the abilities of persons of ordinary skill in the art and are not described in detail herein.

Enhanced Display Screen

A further consideration, in accordance with a further aspect of the invention, concerns important conditions required for the enhanced display of stereoscopic motion picture sequences, on either a television monitor (video display unit; e.g. a cathode ray tube, LCD, plasma or Surface conduction Electron-emitter display unit), home projection screen or cinema projection screen.

The present inventor has found that it is important to create a special window effect, through which the images are seen, in depth, receding from the edge of this window and sometimes to the horizon. Occasionally images will come through this window, into the auditorium or living room.

It is important to create this window, because then the brain is able to place the illusion of 3D that is being presented to it within the context of a correct understanding of the visual world that it is in, and this is an important part of establishing the viewer's acceptance of what will always be an optical illusion.

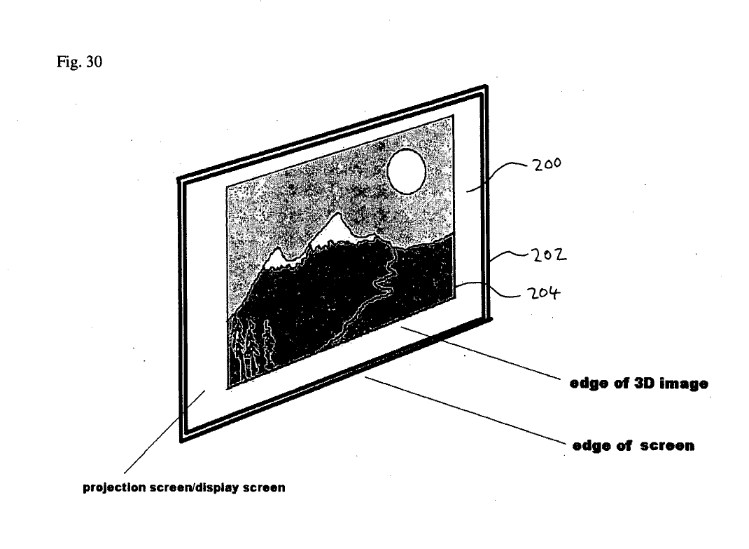

Normally, when images are projected onto a screen 200 (see FIG. 30), the edge 202 of the plane of ‘the window’—which in this case is the projection screen (or display medium screen)—is usually separated from the edge 204 of the projected 3D image by a reasonable margin. The projected image is never allowed to be larger than the screen that it is being projected onto.

The present further aspect of the invention requires that the edge of the window is clearly established as being different to the planes of the 3D images. In order to establish this, the window frame must meet three conditions:

[1] It must be broad—not a thin edge

[2] It must have surface detail which intrudes just sufficiently into the edges of the image—albeit in silhouette outline—to be noticed by viewers

[3] The pattern of this surface detail, and this silhouette, must be irregular.

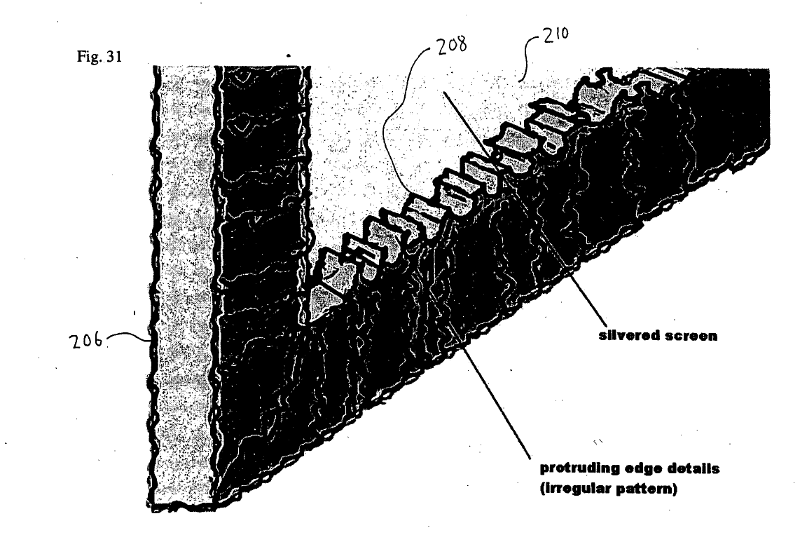

FIG. 31 illustrates one corner of a screen border which meets these three conditions, showing the sort of design that may be implemented in order to enhance and display stereoscopic motion picture sequences in accordance with the previously described aspects of the present invention, or conventional stereoscopic motion picture sequences.

If should also be noted that these design requirements are quite unlike any existing screen designs.

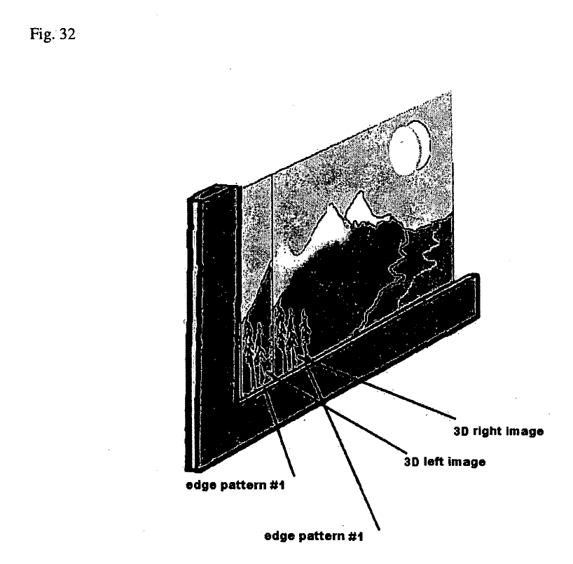

The reasons for the requirements stated above are as follow:

[1] it should be broad—this is so that the delineation between the room, (the environment that the viewer is in) and the 3D images is clearly established, and the size of the border must be such that it can be clearly seen even in near total darkness, as separating the image from the room.

[2 It must have surface detail including protruding edge details 208 overlying the periphery of the display area 210—so we can see that [1] allows the viewer in half light and in near total darkness, to see the edge because of its size and breadth, and surface detail. The surface detail 208 allows the brain to get a clear positional fix on the location of the border in true three-dimensional space, and this true depth cue supports very well the depth cues of the image within the borders.

[3] This surface detail 208 must be irregular—this is important, because although the surface detail can be seen on the border, and in silhouette, against the edges of the 3D image, if there was no pattern or the pattern was regular (see FIG. 32), it would allow the brain to match a portion of the pattern that intruded into the left eye image, or if not intruding was visible as being adjacent to it, with its repeated, and therefore offset, equivalent which may then match with the right eye image, which is also offset. This would help put the border and the 3D image in the same plane, which in reality they are—the reality that we are seeking to disguise.

The frame border suitably has a breadth in the range of about 5%-15% of the screen diagonal dimension, preferably about 10%.

The protrusions of the irregular edge pattern suitably have an average depth less than 2% of the screen diagonal dimension, preferably in the range 0.5%-1.5%

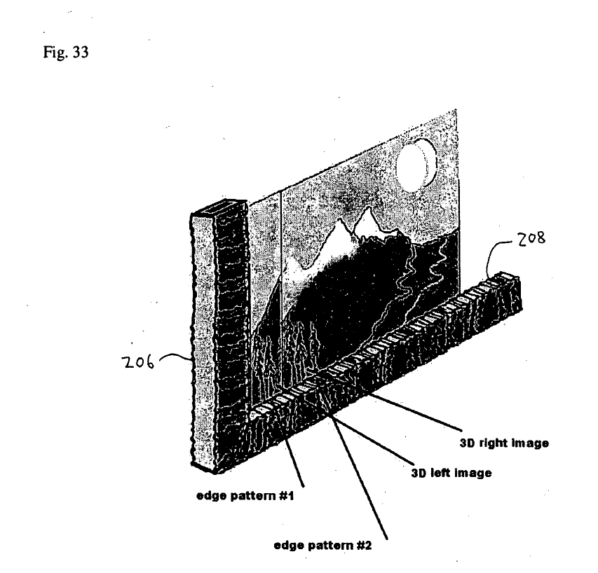

When the pattern is irregular, the brain is forced to match the left eye view of the screen exactly with the right eye view of the screen—which is the normal reality, but this then means that the stereoscopic offset in the displayed 3D images produce a different plane for the image within the borders. The offset of the left eye and right eye 3D image are then perceived as being in a different plane to the border, because the position of the pattern of the border will not now match with the position that it takes with the left eye image and right eye image (see FIG. 33). There will now be a clear ‘perceived’ positional parallax between the border and the 3D image, and this helps the viewer believe the 3D image. This provides a further significant stereo cognitive cue: the discrepancy between the edge of the border, and the 3D images within it.

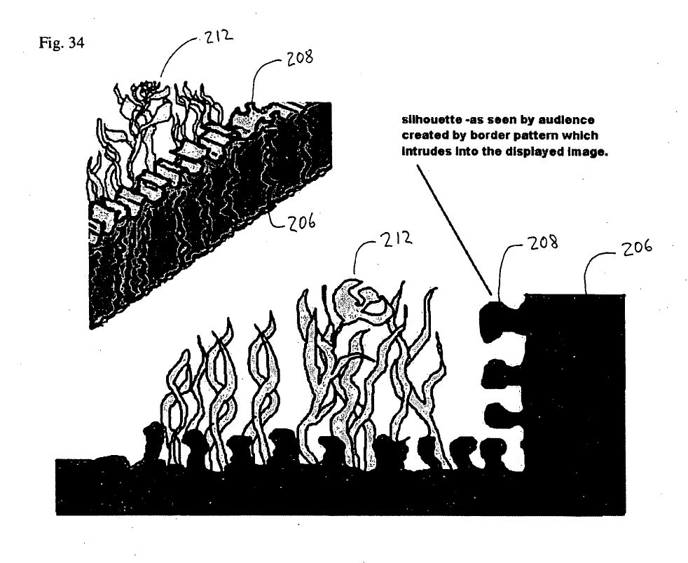

It is also necessary for the projected/displayed image to be slightly larger that the inner margins of the border, so that the image creates a definite margin of silhouetted outline shapes with the border pattern. This establishes an important silhouette perimeter, between the main image 212 and the border (see FIG. 34).

The silhouette perimeter, helps create a ‘through the window’ stereoscopic effect.

Although the design of the border of a projection screen is supportive of and not directly related to the design of the algorithms that produce the converted from 2D into 3D images that will be displayed on that projection screen, the border design plays a significant role in maximizing the effectiveness of the 3D “illusion” created by the algorithms; i.e. whilst not being an essential part of the other aspects of the present invention, the use of border designs such as those described here is very much preferred. The present invention takes a great part of its effectiveness from the understanding that all 3D imaging is an optical illusion that must—if it is to be successful—at no part of its process alert the brain to the artificiality of its image. By making significant changes to aspects of the display frame, stereoscopic motion picture sequences in accordance with the present invention have greater ability to generate physically real stereo cues relative to the redesigned border frame, and these physically real cues augment the artificial stereo cues that the processing places into the image stream, thereby decreasing the likelihood of the brain falling out of the “envelope of deception” that all 3D imaging essentially is.

Instead of being a physical feature of the display screen, an irregular border pattern as described above may be incorporated into the motion picture sequence itself, appearing around the periphery of each frame of each channel. In order to provide the required visual reference, the border pattern may be positioned in the frames of each channel either (a) so that the resolved stereoscopic image of the border pattern appears to the viewer as being in the plane of the display screen or (b) with an offset in the respective channels so that the resolved stereoscopic image of the border pattern appears to the viewer as being slightly in front of the plane of the display screen.

The general principle underlying the use of temporal shadows in accordance with the present invention can be stated broadly to be that the views that are normally sent to either the left eye or the right eye, are now sent to both eyes—in the form of the strong image and the temporal shadow, so that the brain is able to interpret this input as being two images—but received separately from each eye. The temporal shadow image is de-resolved and degraded so that it has more of a subliminal presence—so that the double image does not register too greatly at the conscious level, but registers at the subsequent levels of cognitive processing and understanding. The temporal image contains the all-important 3D information required at the cognitive levels, but is able to some extent to ‘slip under’ the conscious (detection) threshold.

It will be understood that the particular embodiments of the invention as described here in are exemplary and not limiting. Variations, modifications and improvements may be incorporated without departing from the scope of the invention.

1. A stereoscopic motion picture sequence comprising a first channel of sequential images intended for viewing by one of a viewer's left and right eyes and a second channel of sequential images intended for viewing by the other one of the viewer's left and right eyes, wherein each image in each channel comprises primary image content representing a scene consisting of a plurality of elements and temporal shadow image content, said temporal shadow image content in a first image comprising a degraded and/or partially transparent image of at least one element of said primary image content corresponding to a view of said at least one element as seen in the primary image content of a second image from the first or second channel.

2. A stereoscopic motion picture sequence according to claim 1, wherein the temporal shadow image content of the first image is determined on the basis of the degree of displacement between corresponding elements of the first and second images.

3. A stereoscopic motion picture sequence according to claim 2, wherein the temporal shadow image content of the first image is determined on the basis of multiple displacement threshold values or multiple displacement ranges.

4. A stereoscopic motion picture sequence according to claim 2, wherein the degree of degradation and/or the degree of transparency of the temporal shadow image content in the first image depends on the degree of displacement between corresponding elements of the first and second images.

5. A stereoscopic motion picture sequence according to claim 4, wherein the degree of degradation and/or the degree of transparency of the temporal shadow image content in the first image is greater for elements having a greater degree of displacement between corresponding elements of the first and second images.

6. A stereoscopic motion picture sequence according to claim 1, wherein the temporal shadow image content of the first image corresponds to all of the primary image content of the second image.

7. A stereoscopic motion picture sequence according to claim 1, wherein the first image is at a first sequential position in one of said first and second channels and the second image is in the same sequential position in the other of said first and second channels.

8. A stereoscopic motion picture sequence according to claims 1, wherein the second image precedes the first image in the motion picture sequence.

9. A stereoscopic motion picture sequence according to claims 1, wherein the second image succeeds the first image in the motion picture sequence.

10-18. (canceled)

19. A stereoscopic motion picture sequence according to claim 1, wherein said first and second channels comprise identical image sequences that are laterally shifted relative to each other.

20. A stereoscopic motion picture sequence according to claim 19, wherein said image sequences are laterally shifted relative to each other by an amount between 2% and 10% of their overall width.

21-22. (canceled)

23. A stereoscopic motion picture sequence according to claims 19, wherein one of said identical image sequences is delayed in time relative to the other by a predetermined time delay period.

24. A stereoscopic motion picture sequence according to claim 23, wherein each image is a complete image frame and the time delay period corresponds to a delay of up to five image frames.

25-30. (canceled)

31. A stereoscopic motion picture sequence as claimed in claim 1, encoded in a predetermined format and recorded in any tangible medium.

32. A method of producing a stereoscopic motion picture sequence comprising a first channel of sequential images intended for viewing by one of a viewer's left and right eyes and a second channel of sequential images intended for viewing by the other one of the viewer's left and right eyes, wherein each image in each channel comprises primary image content representing a scene consisting of a plurality of elements, the method comprising:
in each image, blending temporal shadow image content with said primary image content, wherein
said temporal shadow image content for a first image comprising a degraded and/or partially transparent image of at least one element of said primary image content corresponding to a view of said at least one element as seen in the primary image content of a second image from the first or second channel.

33. A method according to claim 32, comprising determining the temporal shadow image content of the first image on the basis of the degree of displacement between corresponding elements of the first and second images.

34. A method according to claim 33, wherein the temporal shadow image content of the first image is determined on the basis of multiple displacement threshold values or multiple displacement ranges:

35. A method according to claim 33, wherein the degree of degradation and/or the degree of transparency of the temporal shadow image content in the first image is dependent on the degree of displacement between corresponding elements of the first and second images.

36. A method according to claim 35, wherein the degree of degradation and/or the degree of transparency of the temporal shadow image content in the first image is greater for elements having a greater degree of displacement between corresponding elements of the first and second images.

37. A method according to claim 32, wherein the temporal shadow image content of the first image corresponds to all of the primary image content of the second image.

38. A method according to claims 32, wherein the first image is at a first sequential position in one of said first and second channels and the second image is in the same sequential position in the other of said first and second channels.

39. A method according to claims 32, wherein the second image precedes the first image in the motion picture sequence.

40. A method according to claims 32, wherein the second image succeeds the first image in the motion picture sequence.

41-49. (canceled)

50. A method according to claims 32, wherein said first and second channels are generated by creating two identical copies of a single image sequence and laterally shifting the two copies relative to each other.

51. A method according to claim 50, wherein said copies are laterally shifted relative to each other by an amount between 2% and 10% of their overall width.

52-53. (canceled)

54. A method according to of claims 50, further including delaying one of said copies in time relative to the other by a predetermined time delay period.

55. A method according to claim 56, wherein each image is a complete image frame and the time delay period corresponds to a delay of up to five image frames.

56-61. (canceled)

62. A method as claimed in claim 32, including encoding said stereoscopic motion picture sequence in a predetermined format and recording it in any tangible medium.

63. A system for producing stereoscopic motion picture sequences comprising a first channel of sequential images intended for viewing by one of a viewer's left and right eyes and a second channel of sequential images intended for viewing by the other one of the viewer's left and right eyes, wherein each image in each channel comprises primary image content representing a scene consisting of a plurality of elements and temporal shadow image content, said temporal shadow image content in a first image comprising a degraded and/or partially transparent image of at least one element of said primary image content corresponding to a view of said at least one element as seen in the primary image content of a second image from the first or second channel, said system comprising:
an input for receiving as input sequences of sequential images;
a data store for storing selected ones of said images;
a comparator for comparing the content of stored images to determine temporal shadow image content;
an integrator for blending temporal shadow image content with primary image content of said images to create modified images comprising said primary image content and said temporal shadow image content; and
an output for generating as output sequences of said modified images.

64. A system as claimed in claim 63, wherein said input is adapted to receive a single 2D sequence of sequential images for processing by said data store, comparator and integrator so as to generate a single channel sequence of said modified images, the system further including a duplicator for duplicating said single channel sequence to create identical first and second channel sequences, and a lateral shifter for laterally shifting the first and second channel sequences relative to each other.

65. A system as claimed in claim 64, further including a delay mechanism for delaying one of said channel sequences in time relative to the other by a predetermined time delay period.

66-67. (canceled)

68. A display screen for the display of stereoscopic motion picture sequences comprising a display area surrounded by a border, an inner edge of said border defining a boundary between the border and the periphery of the display area, wherein said inner edge includes protruding edge details in an irregular pattern around said boundary that overlie the periphery of the display area so as to be visible at least in silhouette to viewers of the display.

69. A display screen as claimed in claim 68, wherein the frame border has a breadth in the range of 5%-15% of the screen diagonal dimension.

70. (canceled)

71. A display screen as claimed in of claims 68, wherein protrusions of the irregular edge pattern have an average depth less than 2% of the screen diagonal dimension.

72. (canceled)

73. A display screen as claimed in claims 68, wherein the display screen is the display screen of a projection display system.

74. A display screen as claimed in claim 73, wherein the display area is silvered.

75. A display screen as claimed in claims 68, wherein the display screen is the display screen of a video display unit.

76. (canceled)

77. A stereoscopic motion picture sequence as claimed in claims 1, wherein the images of each channel include an irregular border pattern around the periphery of the image area that protrudes into the edges of the primary image content so as to be visible at least in silhouette to viewers of the motion picture sequence.

78-79. (canceled)

80. A stereoscopic motion picture sequence as claimed in claims 74, wherein protrusions of the irregular edge pattern have an average depth less than 2% of the screen diagonal dimension.

81. (canceled)

82. A method as claimed in claims 32, further including the step of including in each of the images of each channel an irregular border pattern around the periphery of the image area that protrudes into the edges of the primary image content so as to be visible at least in silhouette to viewers of the motion picture sequence.

83-84. (canceled)

85. A method as claimed in claims 82-84, wherein protrusions of the irregular edge pattern have an average depth less than 2% of the screen diagonal dimension.

86. (canceled)

87. A computer program encoded on a data carrier for producing a stereoscopic motion picture sequence comprising a first channel of sequential images intended for viewing by one of a viewer's left and right eyes and a second channel of sequential images intended for viewing by the other one of the viewer's left and right eyes, wherein each image in each channel comprises primary image content representing a scene consisting of a plurality of elements, comprising:
computer readable program code for, in each image, causing blending of temporal shadow image content with said primary image content, said temporal shadow image content for a first image comprising a degraded and/or partially transparent image of at least one element of said primary image content corresponding to a view of said at least one element as seen in the primary image content of a second image from the first or second channel.
